(19) United States
(12) Patent Application Publication
(10) Pub. No.: US 2025/0139195 A1
(43) Pub. Date: May 1, 2025

(54) FASTER MATRIX MULTIPLICATION FOR SMALL BLOCKS

(71) Applicant: YISSUM RESEARCH DEVELOPMENT COMPANY OF THE HEBREW UNIVERSITY OF JERUSALEM LTD., Jerusalem (IL)

(72) Inventors: Oded SCHWARTZ, Kiryat Ono (IL); Yoav MORAN, Jerusalem (IL)

(21) Appl. No.: 18/835,524

(22) PCT Filed: Feb. 3, 2023
(86) PCT No.: PCT/IL2023/050123

§ 371 Date: Aug. 2, 2024

Related U.S. Application Data
(60) Provisional application No. 63/267,507, filed on Feb. 3, 2022.

(51) Int. Cl. G06F 17/16

(52) U.S. Cl. CPC G06F 17/16

(57) ABSTRACT

A computer-implemented method comprising: receiving, as input, matrices A, B and a linear combination of blocks for a main multiplications operation with respect to the input matrices A, B; applying an inner matrix multiplication algorithm to calculate separately: (i) the main multiplications of input matrices A, B, using the linear combination of blocks, (ii) correction terms for the input matrix A, and (iii) correction terms for the input matrix B; and combining the results of the calculating, to obtain a matrix multiplication operation result C of the input matrices A, B.

### CROSS-REFERENCE TO RELATED APPLICATIONS

This application claims the benefit of priority of U.S. Provisional Patent Application No. 63/267,507, filed Feb. 3, 2022, entitled “MATRIX MULTIPLICATION FASTER THAN CLASSICAL, EVEN ON SMALL BLOCKS,” the contents of which are incorporated herein by reference in their entirety.

### BACKGROUND

The invention relates to the field of computerized mathematical applications.

Matrix multiplication is used in a wide range of computerized applications, from image processing to genetic analysis. For example, matrix multiplication is used in cryptography, random numbers, error correcting codes, machine learning, and image processing. One example is in cryptanalysis, where chained operations described as matrices must be multiplied together before being analyzed for flaws. Another example is in the design of random-number generators, where exponentiation (i.e. repeated multiplication) of dense matrices is used to determine the period and quality of random number generators.

Fast matrix multiplication algorithms are a class of divide-and-conquer algorithms, which use fewer multiplications than the classic algorithm. However, fast matrix algorithms typically require more operations in the base case, and, as a result, efficient fast algorithm implementations use the classical algorithm on sufficiently small blocks. This is because the classical algorithm requires fewer operations on small blocks, and is thus considered to be faster for solving small blocks.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There provided, in an embodiment, a system comprising at least one hardware processor; and a non-transitory computer-readable storage medium having stored thereon program instructions, the program instructions executable by the at least one hardware processor to: receive, as input, matrices A, B, and a linear combination of blocks for a main multiplications operation with respect to the input matrices A, B, apply an inner matrix multiplication algorithm to calculate separately: (i) the main multiplications of said input matrices A, B, using the linear combination of blocks, (ii) correction terms for the input matrix A, and (iii) correction terms for the input matrix B, and combine the results of the calculating, to obtain a matrix multiplication operation result C of the input matrices A, B.

There is also provided, in an embodiment, a computer-implemented method comprising: receiving, as input, matrices A, B and a linear combination of blocks for a main multiplications operation with respect to the input matrices A, B; applying an inner matrix multiplication algorithm to calculate separately: (i) the main multiplications of said input matrices A, B, using the linear combination of blocks, (ii) correction terms for the input matrix A, and (iii) correction terms for the input matrix B; and combining the results of the calculating, to obtain a matrix multiplication operation result C of the input matrices A, B.

There is further provided, in an embodiment, a computer program product comprising a non-transitory computer-readable storage medium having program instructions embodied therewith, the program instructions executable by at least one hardware processor to: receive, as input, matrices A, B, and a linear combination of blocks for a main multiplications operation with respect to the input matrices A, B; apply an inner matrix multiplication algorithm to calculate separately: (i) the main multiplications of said input matrices A, B, using the linear combination of blocks, (ii) correction terms for the input matrix A, and (iii) correction terms for the input matrix B; and combine the results of the calculating, to obtain a matrix multiplication operation result C of the input matrices A, B.

In some embodiments, the program instructions are further executable to apply an outer matrix multiplication algorithm to determine the linear combination of blocks.

In some embodiments the outer matrix multiplication algorithm comprises a recursive non-commutative matrix multiplication algorithm.

In some embodiments, the calculating of the correction terms for the input matrix A and correction terms for the input matrix B is performed by the outer matrix multiplication algorithm.

In some embodiments, the outer matrix multiplication algorithm having encoding/decoding matrices [symbol] U^{O}, V^{O}, W^{O} [symbol] is selected based on at least one of the following criteria: having a small leading coefficient, and having a low rank of the tensors [symbol] U^{O},U^{O},W° [symbol] and [symbol] V^{O},V^{O},W^{O} [symbol] .

In some embodiments, the inner matrix multiplication algorithm comprises a commutative matrix multiplication algorithm.

In some embodiments, the applying of the inner matrix multiplication algorithm comprises: (i) receiving encoding/decoding matrices (U^{I}, V^{I}, W^{II}) of the inner matrix multiplication algorithm; and (ii) dividing the received encoding/decoding matrices into three algorithms (ALG_{A}, ALG_{B}, ALG_{AB}), wherein ALG_{A} is configured to calculate the correction terms for the input matrix A that depend only on input matrix A, ALG_{B} is configured to calculate the correction terms for the input matrix B that depend only on input matrix B, and ALG_{AB} is configured to calculate the main multiplication of input matrices A, B.

In some embodiments the calculating of the correction terms for the input matrices A, B utilizes duplicate rows in the respective encoding matrices for the correction terms for the input matrices A, B, respectively, to reduce the cost of the calculating of the correction terms.

In some embodiments, the applying of the outer matrix multiplication algorithm further comprises applying a transformation to at least one of the input matrix A, input matrix B, and matrix multiplication operation result C, by multiplying the at least one of the input matrix A, input matrix B, and matrix multiplication operation result C by an invertible basis transformation.

In some embodiments, the invertible basis transformation is homomorphic over the same linear space.

In some embodiments, at least one of the applications comprises multiplying by a non-homomorphic transformation into a linear space of any intermediate dimension.

In some embodiments, the program instructions are further executable to repeat, and the method further comprises repeating, the receiving, the applying, and the combining recurrently, with respect to a series of two or more consecutive sets of input matrices A, B, wherein one of the input matrices A or B is unchanged in at least some of the consecutive sets.

In some embodiments, the program instructions are further executable to perform, and the method further comprises performing, the receiving, the applying, and the combing with respect to only a portion of the matrix multiplication operation.

There is further provided, in an embodiment, a computer-implemented method comprising: receiving numerical inputs A, B, and a linear combination of segments for a main multiplications operation with respect to the numerical inputs A, B; applying an inner bilinear algorithm to calculate separately: (i) the main multiplications of the numerical inputs A, B, using the linear combination of segments; (ii) correction terms for the numerical input A, and (iii) correction terms for the numerical input B; and combining the results of the calculating, to obtain a bilinear operation result with respect to the numerical inputs A, B.

In some embodiments, the method further comprises applying an outer algorithm to determine the linear combination of segments.

In some embodiments, the calculating of the correction terms for the numerical input A and correction terms for the numerical input B is performed by the outer algorithm.

In some embodiments, the outer algorithm is selected based on at least one of the following criteria: having a small leading coefficient, and having a low rank of the tensors (U,U,W) and (V,V,W).

In some embodiments, the applying of the inner bilinear algorithm comprises: (i) receiving encoding/decoding matrices (U^{I}, V^{I}, W^{II}) of the inner bilinear algorithm; and (ii) dividing the received encoding/decoding matrices into three algorithms (ALG_{A}, ALG_{B}, ALG_{AB}), wherein ALG_{A} is configured to calculate the correction terms for the numerical input A that depend only on numerical input A, ALG_{B} is configured to calculate the correction terms for the numerical input B that depend only on numerical input B, and ALG_{AB} is configured to calculate the main multiplication of numerical inputs A, B.

In some embodiments, the calculating of the correction terms for the numerical inputs A, B utilizes duplicate rows in the respective encoding matrices for the correction terms for the numerical inputs A, B, respectively, to reduce the cost of the calculating of the correction terms.

In some embodiments, the applying of the outer algorithm further comprises applying a transformation to at least one of the numerical input A, numerical input B, and bilinear operation result, by multiplying the at least one of the numerical input A, numerical input B, and bilinear operation result by an invertible basis transformation.

In some embodiments, the invertible basis transformation is homomorphic over the same linear space.

In some embodiments, at least one of the applications comprises multiplying by a non-homomorphic transformation into a linear space of any intermediate dimension.

In some embodiments, the method further comprises repeating the receiving, the applying, and the combining recurrently, with respect to a series of two or more consecutive sets of numerical inputs A, B, wherein one of the input matrices A or B is unchanged in at least some of the consecutive sets.

In some embodiments, the method further comprises performing the receiving, the applying, and the combing with respect to only a portion of the bilinear operation result.

There is further provided, in an embodiment, a computer-implemented method comprising: receiving numerical inputs A₁, . . . , Aₖ, and a linear combination of segments for a main multiplications operation with respect to the numerical inputs A₁, . . . , Aₖ; applying an inner multilinear algorithm to calculate separately: (i) the main multiplications of the numerical inputs A₁, . . . , Aₖ, using the linear combination of segments, and (ii) correction terms for at least some subsets of the numerical inputs A₁, . . . , Aₖ; and (iii) combining the results of the calculating, to obtain a multilinear operation result with respect to the numerical inputs A₁, . . . , Aₖ.

In some embodiments, the method further comprises applying an outer algorithm to determine the linear combination of segments.

In some embodiments, the calculating of the correction terms for at least a subset B₁, . . . , Bₘ of the numerical inputs A₁, . . . , Aₖ is performed by the outer algorithm.

In some embodiments, the outer algorithm having encoding/decoding matrices U₁^{O}, . . . Uₖ^{O},W^{O}) is selected based on at least one of the following criteria: having a small leading coefficient, and having a low rank of the tensors corresponding to the correction terms.

In some embodiments, the applying of the inner multilinear algorithm comprises: (i) receiving encoding/decoding matrices (U₁^{l}, . . . Uₖ^{l},W^{l}) of the inner multilinear algorithm; and (ii) dividing the received encoding/decoding matrices into a main multiplication algorithm and one or more correction algorithms, wherein each of the correction algorithms may depend on a respective specified subset of the numerical inputs A₁, . . . , Aₖ.

In some embodiments, the calculating of the correction terms for the numerical inputs A₁, . . . , Aₖ utilizes duplicate rows in the respective encoding matrices for the correction terms for the numerical inputs A₁, . . . , Aₖ, respectively, to reduce the cost of the calculating of the correction terms.

In some embodiments, the applying of the outer algorithm further comprises applying a transformation to at least one of the numerical inputs A₁, . . . , Aₖ and the multilinear operation result, by multiplying the at least one of the numerical inputs A₁, . . . , Aₖ and the multilinear operation result by an invertible basis transformation.

In some embodiments, the invertible basis transformation is homomorphic over the same linear space.

In some embodiments, at least one of the applications comprises multiplying by a non-homomorphic transformation into a linear space of any intermediate dimension.

In some embodiments, the method further comprises repeating the receiving, the applying, and the combining recurrently, with respect to a series of two or more consecutive sets of numerical inputs A₁, . . . , Aₖ, wherein at least one of the numerical inputs A₁, . . . , Aₖ remains unchanged in at least some of the consecutive sets.

In some embodiments, the method further comprises performing the receiving, the applying, and the combing with respect to only a portion of the multilinear operation.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary system which provides for reducing the computational cost of multiplying small block matrices, in accordance with some embodiments of the present invention;

FIGS. 2A-2C are flowcharts of the functional steps in methods for reducing the computational cost of multiplying inner small sub-blocks in a matrix multiplication algorithm, in accordance with some embodiments of the present invention; and

FIGS. 3A-3E illustrate the computation graphs of multiplying two n×n matrices using a fast recursive algorithm, then switching to b×b blocks multiplication using one of three base case algorithms, in accordance with some embodiments of the present invention.

### DETAILED DESCRIPTION

Disclosed herein is a technique, embodied in a system, computer-implemented method, and computer program product, for reducing the computational cost of implementing matrix multiplication, bilinear recursive, and multi-linear algorithms.

In a particular exemplary embodiment, the present technique provides for reducing the computational cost of multiplying inner small sub-blocks in a matrix multiplication algorithm.

The present disclosure will discuss extensively implementations of the present technique within the context of matrix multiplication algorithms. However, the present technique may be equally effective for any bilinear and/or multilinear algorithms, including, but not limited to, long integer multiplication, polynomial convolution, and chain matrix multiplication.

In some embodiments, the present technique may be applied to matrix multiplication algorithms of any size. In some embodiments, the technique may be applied to any numerical linear algebra applications, such as matrix inversion, matrix polynomials, matrix decompositions (e.g., Cholesky decomposition, LU decomposition, QR decomposition etc.), and/or the like. In some embodiments, the present technique may be applied to mathematical operations involving fewer or more than two matrices, such as matrix powers, matrix inversion, matrix decomposition, matrix polynomial computation, chain matrix multiplication, multivariate polynomial analysis, Hadamard matrix computation, Vandermonde matrices computation, tensor contraction, and/or the like.

In some embodiments, the present technique provides for a matrix multiplication algorithm for small inner sub-blocks of input matrices. In some embodiments, the present technique provides for trading multiplication operations with addition operations, and is thus faster than the classical algorithm when multiplying small blocks. In some embodiments, the present commutative algorithms generalize Winograd's folding technique (1968) (see, Shmuel Winograd. 1968. A New Algorithm for Inner Product. IEEE Trans. Comput. C-17 (1968), 693-694. Issue 7. https://doi.org/10.1109/TC.1968.227420.) and combine it with fast matrix multiplication algorithms. Thus, when a single scalar multiplication requires p times more clock cycles than an addition (e.g., for 16-bit integers on Intel's Skylake microarchitecture, ρ is between 1.5 and 5), the present technique reduces the computation cost of multiplying the small sub-blocks by a factor of

$$\frac{ρ + 3}{2 ( ρ + 1 )}$$

compared to using the classical algorithm, at the price of a low order term communication cost overhead both in the sequential and the parallel cases, thus reducing the total runtime of the algorithm.

In some embodiments, the present technique also reduces the energy cost of the algorithm. The ρ values for energy costs are typically larger than the ρ values for arithmetic costs. For example, the present algorithm is configured for multiplying 2×2 blocks using only four multiplications, which is lower than the lower bound of Winograd (1971) on multiplying 2×2 matrices, by bypassing the implicit assumptions of the lower bound. Thus, in some embodiments, the present algorithm provides a new lower bound for 2×2 block multiplication.

By way of background, fast matrix multiplication algorithms are a class of divide—and—conquer algorithms which use a base [symbol] l, m, n; t [symbol] —algorithm recursively: an algorithm to multiply an l×m matrix by an m×n matrix using t scalar multiplications, where l, m, n, t ∈ [symbol] . The base cases of fast algorithms use fewer multiplications than the classic algorithm. However, they require more operations in the base case. As a result, efficient fast algorithm implementations typically use the classical algorithm on sufficiently small blocks.

A matrix multiplication algorithm is commutative if it requires that any two elements x, y of the input matrices satisfy x·y=y·x. Commutative algorithms trade up to half of total number of multiplication operations with addition operations, as compared to non-commutative algorithms. That is, they use fewer multiplications at the cost of more additions. This means that the run time of commutative algorithms may be shorter than their non-commutative counterparts when a single scalar multiplication costs more than an addition. However, matrix multiplication is not commutative in general (A·B≠B·A). Therefore, commutative algorithms cannot be used recursively in the same way fast algorithms are. Commutative algorithms can still be used at the base case of another recursive matrix multiplication algorithm.

Accordingly, in some embodiments, the present technique provides for a matrix multiplication algorithm for small block multiplication, which combines a commutative algorithm with a non-commutative algorithm.

In some embodiments, the present technique combines two matrix multiplication algorithms to compute the multiplication between two input matrices. The first algorithm is an ‘outer’ recursive non-commutative matrix multiplication algorithm, and the second is an ‘inner’ commutative matrix multiplication algorithm. In some embodiments, the inner algorithm is divided into three parts: the main multiplications depend on both input matrices, whereas the correction terms for each input matrix depend only on the relevant matrix. In some embodiments, the present technique uses the duplicate rows in the encoding matrices of the ‘outer’ algorithm to save computations of the correction terms, by multiplying the same block from the first input matrix by multiple blocks from the second input matrix. Thus, the present technique needs to calculate the correction terms for this block only once.

In some embodiments, the ‘outer’ recursive non-commutative algorithm may be selected to have (i) a small leading coefficient (e.g., as determined by the calculation in Beniamini and Schwartz (see, Gal Beniamini and Oded Schwartz. 2019. Faster matrix multiplication via sparse decomposition. Annual ACM Symposium on Parallelism in Algorithms and Architectures (6 2019), 11-22.https://doi.org/10.1145/3323165.3323188; Elaye Karstadt and Oded Schwartz. 2020. Matrix Multiplication, a Little Faster. Journal of the ACM (JACM) 67, 1 (2020), 1-31.); and/or (ii) a low rank of the tensors [symbol] U, U, W [symbol] and [symbol] V, V, W [symbol] . The small leading coefficient reduces the total cost of the algorithm by the same factor for any matrices size, while the low rank of the tensors yields a better improvement the larger the matrices.

In some embodiments, the ‘inner’ commutative matrix multiplication algorithm may be selected to reduce the costs of the main multiplications as much as possible, as well as to reduce the costs of the correction terms.

In some embodiments, the combination of the commutative and non-commutative algorithms reduces an arithmetic cost, as compared to existing commutative algorithms. As shown in Tables 1 and 2 below, the present technique attains the lower bound and replaces half of the multiplications with additions, regardless of the size of the sub-blocks, as long as the matrices are sufficiently large. In some embodiments, the present technique reaches the lower bounds in the number of multiplications and the number of arithmetic operations up to a low-order term. For example, if a scalar multiplication costs a maximum of p additions, then no commutative algorithm can improve the run time of a non-commutative algorithm that uses t multiplications and q linear operations by a factor larger than

$$\frac{\frac{ρ + 1}{2} t + q}{t ρ + q} .$$

Theorem 1.1: Let n ∈ N be an even integer. Assume the classical [symbol] n, n, n; n³ [symbol] —algorithm has the lowest arithmetic cost among all [symbol] n, n, n; t [symbol] —algorithms. Then GFA has the lowest arithmetic cost among all commutative algorithm for computing sub-blocks of dimensions [symbol] n, n, n [symbol] up to a low order term if dᵤ dᵥ<t in the outer algorithm.

Table 1 below shows the arithmetic costs of a 2×2 block multiplication using various algorithms and corresponding lower bounds. These are amortized costs for computing a single block multiplication, excluding the cost of the fast recursive matrix multiplication algorithm that utilizes block multiplication at the base of the recursion while including any other computation. The assumptions column states the conditions the algorithm or the lower bound requires. The o(1) refers to the size of the whole matrix.

TABLE 1

| | | | |
|---|---|---|---|
| Algorithm | Multiplications | Additions | Assumptions |

Non-commutative
Algorithm

| | | | |
|---|---|---|---|
| Classic | 8 | 4 | — |
| ^{[1]} | 7 | 18 | — |
| ^{[2]} | 7 | 15 | — |
| ^{[3]} | 7 | 12 + | Part of a recursive algorithm |
| | | o(1) | |

Lower Bound

| | | | |
|---|---|---|---|
| ^{[4]} | 7 | | Over F₂ |
| ^{[5]} | 7 | | Over a general field |
| ^{[6]} | | 15 | 7 multiplications over F₂ |
| ^{[7]} | | 15 | 7 multiplications over a |
| | | | general field |
| ^{[3]} | | 12 | 7 multiplications, part |
| | | | of a recursive algorithm |

Commutative
Algorithm

| | | | |
|---|---|---|---|
| ^{[8]} | 8 | 16 | — |
| ^{[9]} | 7 | 23 | — |
| Present | 4 + | 8 + | Part of a recursive algorithm |
| Algorithm | o(1) | o(1) | |

Lower Bound

| | | | |
|---|---|---|---|
| ^{[5]} | 7 | | Over a general field |
| Present | 4 | | Homogenous algorithm, part |
| Algorithm | | | of a recursive algorithm |
| Present | | 8 | 4 multiplications |
| Algorithm | | | |

^{[1]} Volker Strassen. 1969. Gaussian elimination is not optimal. Numer. Math. 13 (1969). Issue 4. https://doi.org/10.1007/BF02165411
^{[2]} Shmuel Winograd. 1976. Private communication with R. Probert.
^{[3]} Elaye Karstadt and Oded Schwartz. 2020. Matrix Multiplication, a Little Faster. Journal of the ACM (JACM) 67, 1 (2020), 1-31.
^{[4]} John E Hopcroft and Leslie R Kerr. 1971. On minimizing the number of multiplications necessary for matrix multiplication. SIAM J. Appl. Math. 20, 1 (1971), 30-36.
^{[5]} Shmuel Winograd. 1971. On multiplication of 2 × 2 matrices. Linear Algebra and Its Applications 4, 4 (1971), 381-388. Issue 4. https://doi.org/10.1016/00243795(71)90009-7
^{[6]} Robert L Probert. 1976. On the additive complexity of matrix multiplication. SIAM J. Comput. 5, 2 (1976), 187-203.
^{[7]} Nader H. Bshouty. 1995. On the additive complexity of 2 × 2 matrix multiplication. Inform. Process. Lett. 56, 6 (1995), 329-335. Issue 6. https://doi.org/10.1016/00200190(95)00176-X.
^{[8]} Shmuel Winograd. 1968. A New Algorithm for Inner Product. IEEE Trans. Comput. C-17 (1968), 693-694. Issue 7. https://doi.org/10.1109/TC.1968.227420.
^{[9]} Abraham Waksman. 1970. On Winograd's Algorithm for Inner Products. IEEE Trans. Comput. C-19 (1970). Issue 4. https://doi.org/10.1109/T-C.1970.222926.

In some embodiments, the present technique improves the arithmetic complexity of the inner sub-blocks in a matrix multiplication algorithm by a factor of

$$\frac{ρ + 3}{2 ρ + 2} .$$

to this end, the present technique generalizes the folding technique of the algorithm from Winograd (1968), and combines the resulting commutative algorithm with fast basis transformation. The resulting algorithm performs better than the classic algorithm even on small blocks, so long as the input matrices are sufficiently large. It also attains the lower bound, and hence may be considered to be optimal.

In some embodiments, the present technique is energy-efficient. As shall be shown hereinbelow, multiplication operations typically require between 2-49 times more energy than addition operations, on a 45-nm chip, and as much as between 3-31 more additions than on a 7-nm chip. This translates to energy savings of between 25-46% on TPU-like implementations of exemplary Algorithm 2 disclosed hereinbelow.

In some embodiments, the present technique may result in a low-order communication overhead, both in the memory hierarchy and inter-processor communication. However, this overhead may be mitigated, at least in part, by employing a hybrid strategy which combines the present technique with standard fast recursive matrix multiplication implementations. The hybrid strategy may trade off inter-processor communication overhead and increased use of faster memory resources. For example, the standard implementation may be used to calculate the first few recursive calls, and then the implementation switches to the present technique, when the entire block fits into the faster memory.

In some embodiments, other recursive bilinear and multi-linear algorithms could benefit from the present technique, including long integer multiplication, convolution, algorithms on graphs that may or may not include matrix multiplication, cryptography, Bitcoin mining, chain matrix multiplication, etc.

In some embodiments, the present technique can be combined with one or more of the following methods for fast matrix multiplication:
The method for fast matrix multiplication using basis transformation, as taught by U.S. Pat. No. 10,387,534 to Schwartz et al., the contents of which are incorporated herein by reference in their entirety. By way of background, the basis transformation technique provides for determining an invertible basis transformation, which is applied to input matrices. The matrix multiplication is then performed on the transformed matrices, and the resulting multiplied matrix is converted back, using the inverted basis transformation.
The method for fast matrix multiplication using sparse decomposition, as taught by International Publication Number WO 2020/183477 and U.S. patent application Ser. No. U.S. Ser. No. 17/437,816 to Schwartz et al., the contents of both of which are incorporated herein by reference in their entirety. By way of background, the sparse decomposition technique provides for matrix multiplication using decompositions that are transformations, which are not necessarily homomorphisms, into a linear space of any intermediate dimension.

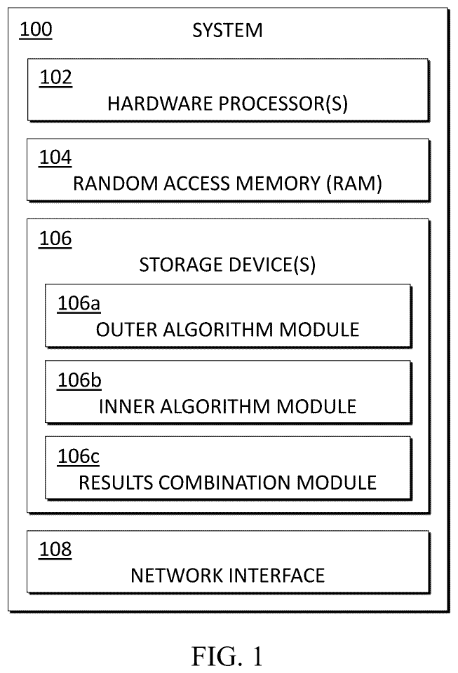

FIG. 1 is a block diagram of an exemplary system 100 which provides for reducing the computational cost of implementing matrix multiplication, bilinear recursive, and multi-linear algorithms, in accordance with some embodiments of the present invention.

In some embodiments, system 100 may comprise a hardware processor 102, and a random-access memory (RAM) 104, one or more non-transitory computer-readable storage device 106, and a network interface 108. In some embodiments, system 100 may store in storage device 106 software instructions or components configured to operate a processing unit (also ‘hardware processor,’ ‘CPU,’ ‘quantum computer processor,’ or simply ‘processor’), such as hardware processor 102. In some embodiments, the software components may include an operating system, including various software components and/or drivers for controlling and managing general system tasks (e.g., memory management, storage device control, power management, etc.) and facilitating communication between various hardware and software components. Components of system 100 may be co-located or distributed, or the system may be configured to run as one or more cloud computing ‘instances,’ ‘containers,’ ‘virtual machines,’ or other types of encapsulated software applications, as known in the art.

Storage device(s) 106 may have stored thereon program instructions and/or components configured to operate hardware processor(s) 102. The program instructions may include one or more software modules, such as an outer algorithm module 106a, inner algorithm module 106b, and/or a results combination module 106c.

Upon receiving input matrices for multiplication, outer algorithm module 106a may be configured to search for a suitable recursive non-commutative ‘outer’ algorithm to perform the calculation of correction terms for each of the input matrices. Outer algorithm module 106a may then be configured to use the encoding/decoding matrices of the algorithm, to determine the encoding/decoding matrices for the correction terms each of the input matrices.

Inner algorithm module 106b may be configured to search for a suitable commutative ‘inner’ algorithm to perform the main matrix multiplication calculations. Inner algorithm module 106b may then be configured to use the encoding/decoding matrices of the ‘inner’ algorithm to split the algorithm into three parts, the first two to perform operations that use, respectively, element from only one of the respective inputs (the correction terms), and the third to perform the main multiplications.

Results combination module 106c may be configured to receive the computations result of the ‘outer’ algorithm from outer algorithm module 106a, and of the ‘inner’ algorithms from the inner algorithm module 106b, and to combine the received results to output the multiplication of the input matrices.

Basis transformation module 102a optionally receives input matrices, determines one or more basis transforms, and applies the basis transforms to transform the input matrices. Matrix multiplication module 102b multiplies the transformed input matrices to produce a transformed results matrix. Results transformer module 102c to produces the resulting multiplied matrix for further processing.

System 100 may use network interface 108 to interface to a Local Area Network (LAN), Wide Area Network (WAN) or the Internet through a variety of connection protocols.

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 100 may be co-located or distributed, or the system may be configured to run as one or more cloud computing ‘instances,’ ‘containers,’ ‘virtual machines,’ or other types of encapsulated software applications, as known in the art.

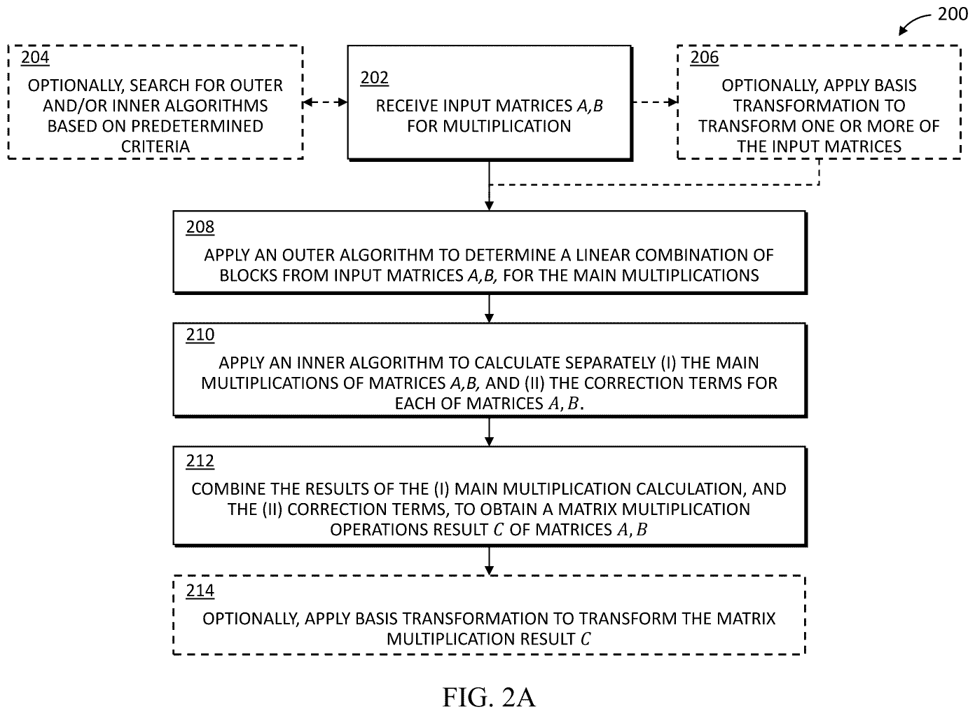

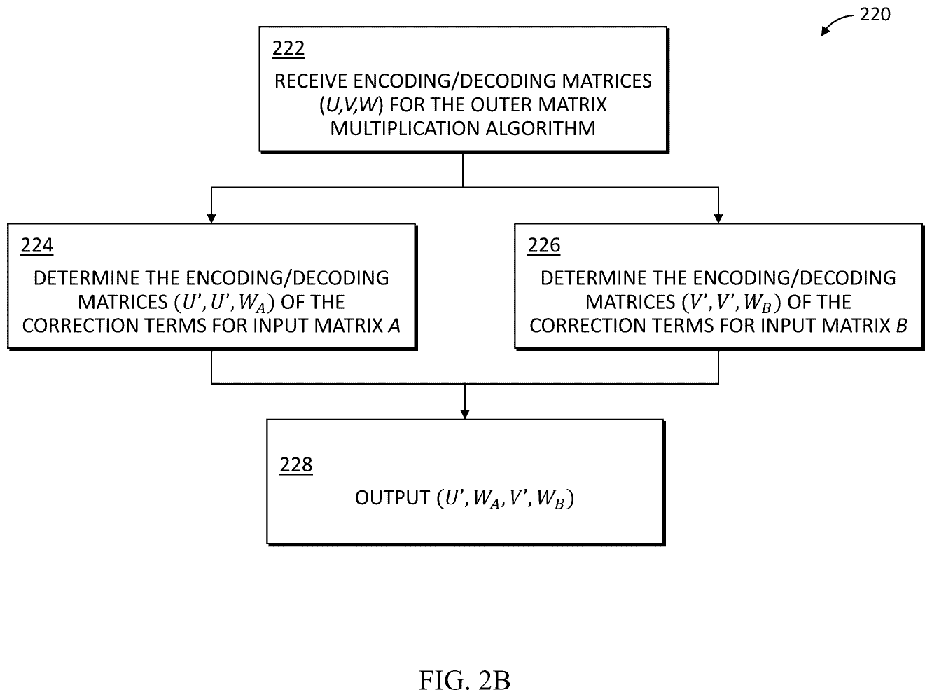

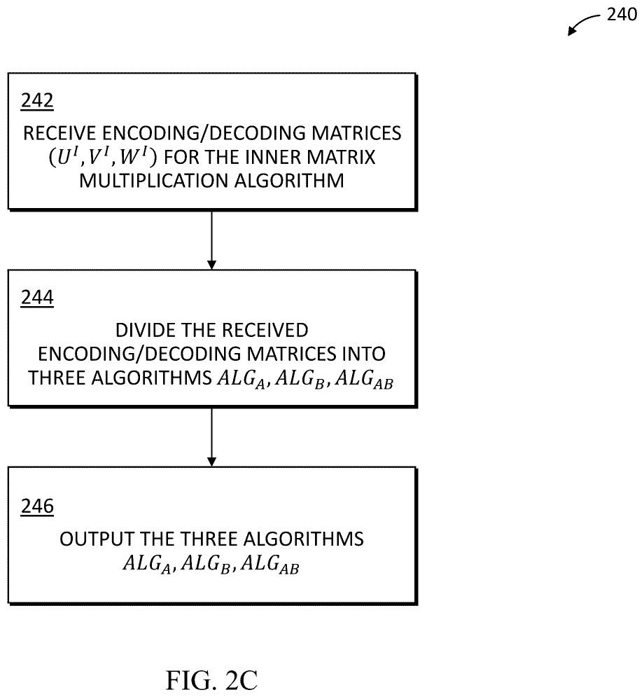

The instructions of system 100 will now be discussed with reference to the flowcharts of FIGS. 2A-2C, which illustrate the functional steps in methods 200, 220, 240, respectively, for reducing the computational cost of implementing matrix multiplication, bilinear recursive, and multi-linear algorithms, in accordance with some embodiments of the present invention.

The various steps of methods 200, 220, 240 will be described with continuous reference to exemplary system 100 shown in FIG. 1. The various steps of methods 200, 220, 240 may either be performed in the order they are presented or in a different order (or even in parallel), as long as the order allows for a necessary input to a certain step to be obtained from an output of an earlier step. In addition, the steps of methods 200, 220, 240 may be performed automatically (e.g., by system 100 of FIG. 1), unless specifically stated otherwise. In addition, the steps of methods 200, 220, 240 are set forth for exemplary purposes, and it is expected that modifications to the flowchart may be implemented as necessary or desirable.

The description of methods 200, 220, 240 discloses an exemplary implementation of the present technique within the context of matrix multiplication algorithms. However, methods 200, 220, 240 may be equally implemented with respect to any numerical inputs with respect to the application of any one or more bilinear and/or multilinear algorithms, including, but not limited to, long integer multiplication, polynomial convolution, and chain matrix multiplication.

Method 200 begins in step 202, wherein system 100 receives, as input, matrices A, B for multiplication.

In step 204, optionally, the instructions of system 100 may provide for selecting at least one of an ‘outer’ and an ‘inner’ algorithms.

In some embodiments, an outer matrix multiplication algorithm having encoding/decoding matrices [symbol] U^{O}, V^{O}, W^{O} [symbol] may be selected based on at least one of the following criteria: (i) having a small leading coefficient, which reduces the total cost of the algorithm by the same factor for any matrix size, and/or (ii) having a low rank of the tensors [symbol] U^{O}, U^{O}, W^{O} [symbol] and [symbol] V^{O}, V^{O}, W^{O} [symbol] , which yields a better improvement the larger the matrices.

In some embodiments, an inner algorithm of the present technique may be selected to reduce the costs of the main multiplications as much as possible. A second priority is to also reduce the costs of the correction terms.

In step 206, optionally, the instructions of system, 100 provide for applying a transformation to at least one of the input matrices A, B, by multiplying the input matrices A and/or B by an invertible basis transformation. In some embodiments, the invertible basis transformation is homomorphic over the same linear space. In some embodiments, at least one of the transformations is a non-homomorphic transformation into a linear space of any intermediate dimension.

In some embodiments, step 208, the instructions of outer algorithm module 106a may cause system 100 to apply an outer algorithm to, determine a linear combination of blocks from input matrices A, B, for use during the main multiplications operation.

In some embodiments, the outer matrix multiplication algorithm comprises a recursive non-commutative matrix multiplication algorithm.

In some embodiments, the instructions of outer algorithm module 106a may cause system 100 to receive, as input, the linear combination of blocks from input matrices A, B, for use during the main multiplications operation.

In some embodiments, step 210, the instructions of inner algorithm module 106b may cause system 100 to apply an inner commutative matrix multiplication algorithm to calculate separately:
(i) The main multiplications of said input matrices A, B, using the linear combination of blocks from input matrices A, B;
(ii) the correction terms for input matrix A; and
(iii) the correction terms for input matrix B.

In step 212, the instructions of combination module 106c may cause system 100 to combine the results of the (i) main multiplication calculation, and the (ii) correction terms, to obtain a matrix multiplication operations result C of matrices A,B.

In step 214, optionally, the instructions of system 100 may provide for applying a transformation to matrix multiplication operations result C, by multiplying C by an invertible basis transformation. In some embodiments, the invertible basis transformation is homomorphic over the same linear space. In some embodiments, the transformation is a non-homomorphic transformation into a linear space of any intermediate dimension.

Method 220 begins in step 222, wherein the instructions of outer algorithm module 106a may cause system 100 to receive encoding/decoding matrices (U, V, W) of the outer matrix multiplication algorithm.

In steps 224, 226, the instructions of outer algorithm module 106a may cause system 100 to determine the encoding/decoding matrices (U′, U′, W_{A}) of the correction terms for input matrix A, and the encoding/decoding matrices (V′, V′, W_{B}) of the correction terms for said input matrix B.

In step 228, the instructions of outer algorithm module 106a may cause system 100 to output (U′, W_{A}, V′, W_{B}).

Method 240 begins in step 242, wherein the instructions of inner algorithm module 106b may cause system 100 to receive encoding/decoding matrices (U, V, W) of the inner matrix multiplication algorithm.

In step 244, the instructions of inner algorithm module 106b may cause system 100 to divide the received encoding/decoding matrices into three algorithms (ALG_{A}, ALG_{B}, ALG_{AB}).

In some embodiments, ALG_{A} is configured to calculate the correction terms for input matrix A that depend only on input matrix A; ALG_{B} is configured to calculate the correction terms for input matrix B that depend only on input matrix B; and ALG_{AB} is configured to calculate the main multiplication of input matrices A, B.

In step 246, the instructions of inner algorithm module 106b may cause system 100 to output (ALG_{A}, ALG_{B}, ALG_{AB}).

### Notations

Notation 2.1: Let R be a ring and let A, B ∈ R^{K}, then A⊙B denotes their Hadamard (elementwise) product.
Notation 2.2: Let R be a ring, let k, l, n ∈ [symbol] and let A ∈ Rⁿ, B ∈ ^{l}, then A⊗B denotes their Kronecker product, and

$${A}^{⊗ k} ( {\underbrace{A ⊗ ... ⊗ A}}_{ktimes} )$$

is the k^{th} Kronecker power of A.
Notation 2.1: Let R be a ring and let A ∈ R^{n×m} be a matrix. The vectorization of A is \vec{A}=(a_{1,1} . . . , a_{1,m}, . . . , a_{n,1}, . . . , a_{n,m})^{T}.
Notation 2.1: Let R be a ring, let a, b, x, y ∈ [symbol] . Let A ∈ R^{ax·by} be a vector, and let ∀i ∈ [ab]: A⁽ⁱ⁾(A_{(xy)(i-1)+1}, . . . , A_{xyi}). The block segmentation of A is Â(A⁽¹⁾, . . . , A^{(ab)}) ∈ (R^{xy})^{ab}.

### Encoding and Decoding Matrices

The encoding/decoding matrices of a recursive-bilinear algorithm are dented [symbol] U,V, W [symbol] , where U,V are the encoding matrices and W is the decoding matrix. Encoding/decoding matrices, also referred to as coefficient matrices, indicate the coefficients of the variables in a set of linear equations. In the encoding stage, a multiplication is performed by encoding each input into a number of multiplicands. In the decoding stage, the results of the multiplication process are decoded into the actual result of the multiplication. For example, when an algorithm has t multiplications, the left-hand input is encoded into the t left hand multiplicands (S₁, S₂, . . . , Sₜ), and the right-hand input is encoded into the t right hand multiplicands (T₁, T₂, . . . , Tₜ). In this example, the multiplications are computed P₁=S₁*T₁, P₂=S₂*T₂, . . . , Pₜ=Sₜ*Tₜ. The decoding stage converts the results P₁, . . . , Pₜ into the actual output values of the matrix multiplication algorithm.

The encoding and/or decoding matrices used for the bilinear transformation (such as matrix multiplication algorithm), may be augmented by basis transformation and inverse transformation matrices. Accordingly, the encoding/decoding matrices may be specifically computed based on the basis transformation, to be applied to the corresponding specific matrix multiplication algorithm. For example, a basis transformation that sparsifies the encoding and decoding matrices so that the matrix multiplication algorithm requires fewer arithmetic operations.
Fact 2.5: Let ƒ: Rⁿ→R^{m} be a quadratic function over a ring R and let ALG be an arithmetic algorithm that uses t multiplications and divisions. There exist U, V ∈ R^{t×n}, W ∈ R^{t×m} such that—

$$∀ a ∈ {R}^{n} : f ( a ) = {W}^{T} ( ( U \cdot a ) ⊙ ( V \cdot a ) ) .$$

See, Volker Strassen. 1973. Vermeidung von Divisionen. Journal fur die Reine und Angewandte Mathematik 1973 (1973). Issue 264.https://doi.org/10.1515/crll.1973.264.184.

That is, for any arithmetic algorithm ALG, there exists a quadratic algorithm ALG′ that does not use division, where the number of its multiplications is the same as the total number of multiplications and divisions as ALG. Accordingly, it may be assumed, without loss of generality, that any algorithm is of the form stated in Fact 2.5.
Definition 2.6: The [symbol] U,V, W [symbol] of a quadratic algorithm to compute a quadratic function may be referred to as its encoding/decoding matrices (U and V are the encoding matrices and W is the decoding matrix).
Remark 2.7: Permuting the rows of [symbol] U, V, W [symbol] changes only the computation order, so it yields an equivalent algorithm.
Remark 2.8: Note that any bilinear function with inputs A, B is a quadratic function with the input α=(A, B).
Remark 2.9: Denote U=(U^{A}, U^{B}), V=(V^{A}, V^{B}). If the algorithm is non-commutative then U^{B}, V^{A}=0. Therefore, the common notation is to ignore them and only specify [symbol] U^{A}, V^{B}, W [symbol] .

### Example 2.10: Consider the Classic 2,1,2; 4—Algorithm

Its representation using the non-commutative notation is—

$$〈 U , V , W 〉 = 〈 ( \begin{matrix}1 & 0 \\ 1 & 0 \\ 0 & 1 \\ 0 & 1\end{matrix} ) , ( \begin{matrix}1 & 0 \\ 0 & 1 \\ 1 & 0 \\ 0 & 1\end{matrix} ) , ( \begin{matrix}1 & 0 & 0 & 0 \\ 0 & 1 & 0 & 0 \\ 0 & 0 & 1 & 0 \\ 0 & 0 & 0 & 1\end{matrix} ) 〉$$

Its representation using the general notation is

$$〈 U , V , W 〉 = 〈 ( \begin{matrix}1 & 0 & 0 & 0 \\ 1 & 0 & 0 & 0 \\ 0 & 1 & 0 & 0 \\ 0 & 1 & 0 & 0\end{matrix} ) , ( \begin{matrix}0 & 0 & 1 & 0 \\ 0 & 0 & 0 & 1 \\ 0 & 0 & 1 & 0 \\ 0 & 0 & 0 & 1\end{matrix} ) , ( \begin{matrix}1 & 0 & 0 & 0 \\ 0 & 1 & 0 & 0 \\ 0 & 0 & 1 & 0 \\ 0 & 0 & 0 & 1\end{matrix} ) 〉$$

Definition 2.11: Denote the number of non-zero entries in a matrix A by nnz(A)= |{(i, j): A_{i,j}≠0}|, and denote the number of non-singular entries in A by nns(A)=|{(i, j): A_{i,j} ∉{−1,0,1}.
Claim 2.12: Let (U, V, W) be the encoding/decoding matrices of a bilinear function ƒ: Rⁿ×R^{m}→R^{k} and let qᵤ, qᵥ, q_{w} be the number of arithmetic operations performed by the encoding and decoding matrices, correspondingly. Then—

$${q}_{u} = nnz ( U ) + nns ( U ) - t$$

$${q}_{v} = nnz ( V ) + nns ( V ) - t$$

$${q}_{w} = nnz ( W ) + nns ( W ) - k$$

claim 2.13: (Triple product condition) Let R be a ring, let U ∈ R^{t×xy}, V ∈ R^{t×yz}, W ∈ R^{t×zx}, and let δ_{i,j} be Kronecker's delta. [symbol] U,V, W [symbol] are encoding/decoding matrices of an [symbol] x, y, z; t [symbol] —algorithm if and only if for every i₁, i₂ ∈[x], j₁, j₂ ∈ [y], k₁, k₂ ∈ [z] it holds that Σₛ₌₁^{t}U_{s,(i}_{₁}_{,j}_{₁}₎V_{s,(j}_{₂}_{,k}_{₁}₎W_{s,(is,k2)}=δᵢ_{₁}_{,i}_{₂}·δⱼ_{₁}_{,j}_{₂}·δₖ_{₁}_{,k}_{₂}.
Claim 2.13 may be generalized to fit the commutative case. Namely, a necessary and sufficient condition is provided for a quadratic algorithm (U,V, W) to be commutative matrix multiplication algorithm:
Claim 2.14: Let R be a commutative ring, and let U, V ∈ R^{t×(x-y+y-z)}, W ∈ R^{t×z-x} Then [symbol] U,V, W [symbol] are encoding/decoding matrices of a commutative matrix multiplication algorithm of dimensions (x, y, z) if and only if for every i₁, i₂, i₃ ∈ [x], j₁, j₂ ∈ [y], k₁, k₂, k₃ ∈ [z]

$${\sum }_{s = 1}^{t} ( {U}_{s , ( {i}_{1} , {j}_{1} )}^{A} {V}_{s , ( {j}_{2} , {k}_{1} )}^{B} + {U}_{s , ( {j}_{2} , {k}_{1} )}^{B} {V}_{s , ( {i}_{1} , {j}_{1} )}^{A} ) {W}_{s , ( {i}_{2} , {k}_{2} )} = {δ}_{{i}_{1} , {i}_{2}} \cdot {δ}_{{j}_{1} , {j}_{2}} \cdot {δ}_{{k}_{1} , {k}_{2}}$$

$${\sum }_{s = 1}^{t} {U}_{s , ( {i}_{1} , {j}_{1} )}^{A} {V}_{s , ( {i}_{2} , {j}_{2} )}^{A} {W}_{s , ( {i}_{3} , {k}_{1} )} = 0$$

$${\sum }_{s = 1}^{t} {U}_{s , ( {j}_{1} , {k}_{1} )}^{B} {V}_{s , ( {j}_{2} , {k}_{2} )}^{B} {W}_{s , ( {i}_{1} , {k}_{3} )} = 0$$

### Algorithm Composition

Fact 2.15: (Mixed product property) Let R be a ring and let A ∈ R^{m×n}, B ∈ R^{n×p}, C ∈ R^{x×y}, D ∈ R^{y×Z} be matrices over R. Then (A⊗C)·(B⊗D)=(A·B)⊗(C·D).
Fact 2.16: Let (U^{O}, V^{O}, W^{O}) be an (a, b, c; t)—algorithm, and let (U^{I}, V^{I}, W^{II}) be an (x, y, z; t′)—algorithm. Then the standard composition of (U^{O}, V^{O}, W^{O}) with (U^{I}, V^{I}, W^{II}) is

(U^{O},V^{O},W^{O})⊗(U¹,V¹,W¹)=(U^{O},⊗Q^{I},V^{O},⊗V^{I},W^{O}⊗W^{I})
Remark 2.17: The equality in Fact 2.16 is algebraic, but the computation graphs are different. This difference affects the arithmetic cost as well as the communication complexity.
Corollary 2.18: Let (U, V, W) be an (x, y, z; t)—algorithm. Calling (U, V, W) recursively k times yields the (x^{k}, y^{k}, z^{k}; t^{k})—algorithm (U, V, W)^{⊗k} with the encoding/decoding matrices (U^{⊗k}, V^{⊗k}, W^{⊗k}).

Algorithm 1 below illustrates a pseudo-code for fast recursive matrix multiplication implementations. These implementations generally use the classic matrix multiplication algorithm for ALG₁.

Algorithm 1:

Input A ∈ R^{a}_{^{k}}^{x×b}_{^{k}}^{y}, B ∈ R^{b}_{^{k}}^{y×c}_{^{k}}^{z}, k ∈ [symbol]
Output C = A · B ∈ R^{a}_{^{k}}^{x×c}_{^{k}}^{z}

| 1: | Function Composed_Algorithms(A, B, k) | |
|---|---|---|
| 2: | If k = 0 then | |
| 3: | Return ALG₁ (A, B) | |
| 4: | else | |
| 5: | Ã = U^{o} · Â | [symbol] transform the input (see Notation 2.4 above) |
| 6: | \tilde{B} = V^{o} · \hat{B} | |
| 7: | for i = 1, . . . , t do | |
| 8: | \tilde{C}ᵢ = Composed algorithms(Ãᵢ, \tilde{B}ᵢ, k − 1) [symbol] inner blocks multiplication | |
| 9: | return (W^{o})^{T} · \tilde{C} | [symbol] transform the output |

Claim 2.19: Let [symbol] U, V, W [symbol] be the encoding/decoding matrices of an [symbol] x, y, z; t [symbol] and let qw qv, qw be the number of arithmetic operations performed by the encoding and decoding matrices, correspondingly. Let k ∈ [symbol] and denote X=x^{k}, Y=y^{k}, Z=z^{k}. Then the number of arithmetic operations U^{Øk} performs is

$$\frac{{q}_{u}}{t - xy} ( {t}^{k} - XY )$$

and similarly V^{⊗k} performs

$$\frac{{q}_{v}}{t - yz} ( {t}^{k} - YZ )$$

operations and W^{⊗k} performs

$$\frac{{q}_{w}}{t - xz} ( {t}^{k} - XZ )$$

operations.

### Communication Models

In some embodiments, the present technique uses two communication models, the sequential model and the parallel model:
Definition 2.20: The sequential model is a communication model of a two-level machine—a fast memory of size M and an unbounded slow memory. The I/O-complexity is the number of words moved between the levels.
Definition 2.21: Let ALG be an algorithm whose I/O-complexity depends on the parameters x₁, . . . , xₙ. Its I/O-complexity may be denoted by IO_{ALG}(x₁, . . . , xₙ).
Definition 2.22: The parallel model is a communication model of a distributed-memory machine with P identical processors, each with a local memory of size M. The I/O-complexity is the number of words sent and received along the critical path.
Definition 2.23: Let ALG be an algorithm whose I/O-complexity depends on the parameters x₁, . . . , xₙ. Its I/O-complexity is denoted by IO_{ALG}(x₁, . . . , xₙ).
Definition 2.24: The model (parallel or sequential) is always clear from the context. The number of processors P appears only in the parallel model.

Example 2.25: Let CLS be the classical algorithm. Then 10CLS (M, x) is the I/O—complexity of computing the classical algorithm in the sequential model for square matrices of dimensions x×x using fast memory of size M. IO_{CLS}(P, M, x) is the I/O-complexity of computing the classical algorithm in the parallel model for square matrices of dimensions x×x using P processors each with local memory of size M.

### Implementations

In some embodiments, the present technique provides for using commutative algorithms for the innermost layer of a recursive bilinear algorithm. This implementation presents a tight lower bound on the number of multiplications and the number of arithmetic operations commutative algorithms require. The present discussion will analyze only the square matrices case, however, the rectangular matrices case follows similarly.

### Improved Composition

In some embodiments, the present technique provides for composing a non-commutative algorithm with a commutative algorithm, in a way that is more efficient as compared to the standard composition presented in Fact 2.16 above. The multiplications of each commutative algorithm are split into two types: main multiplications and correction terms. Correction terms may be re-used in multiple block multiplications in order to save arithmetic operations.

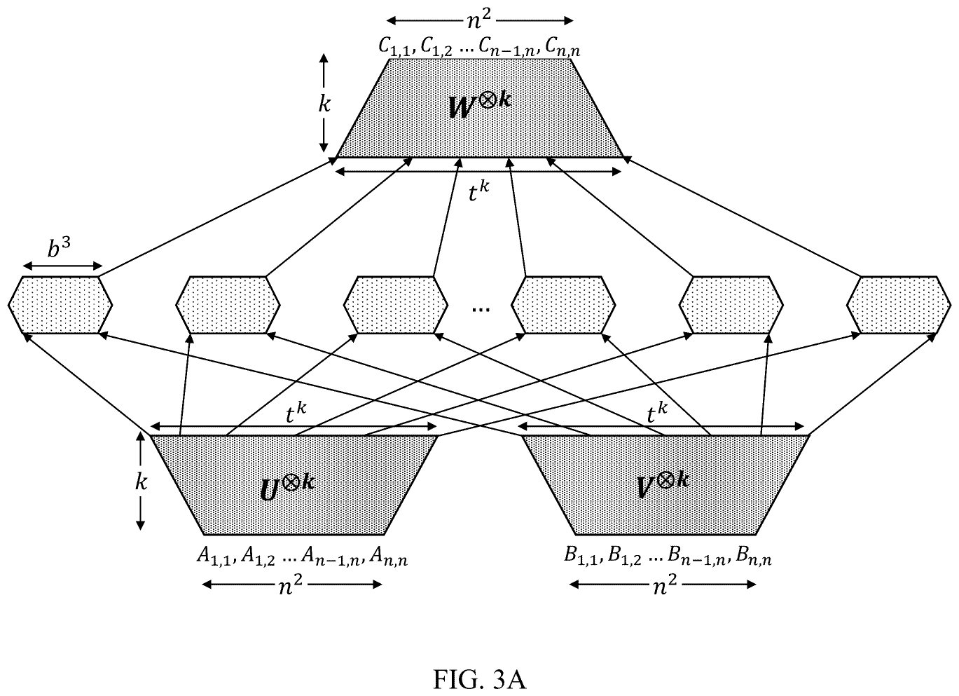

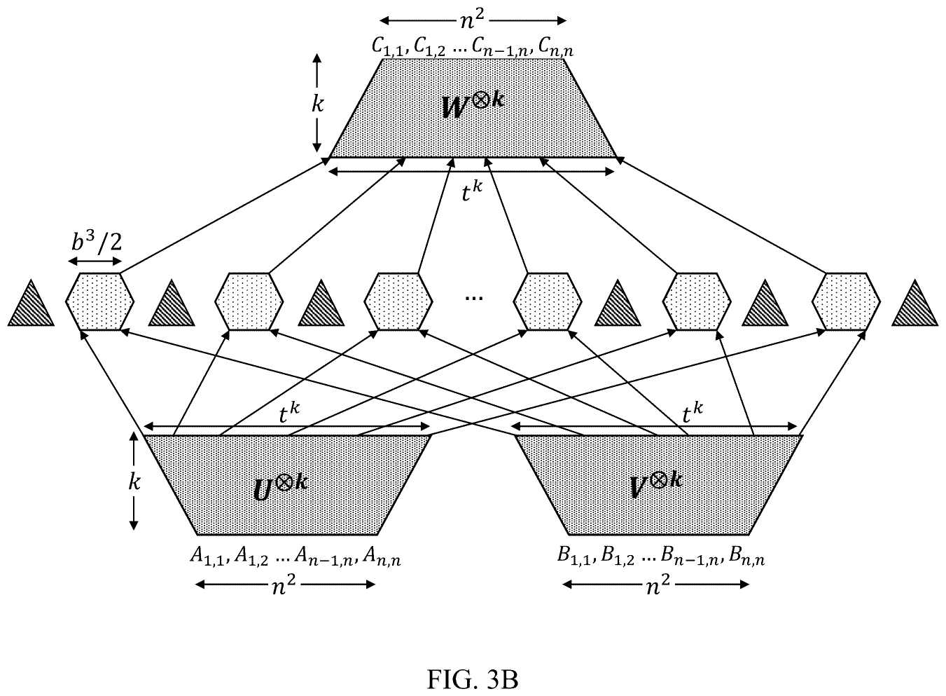

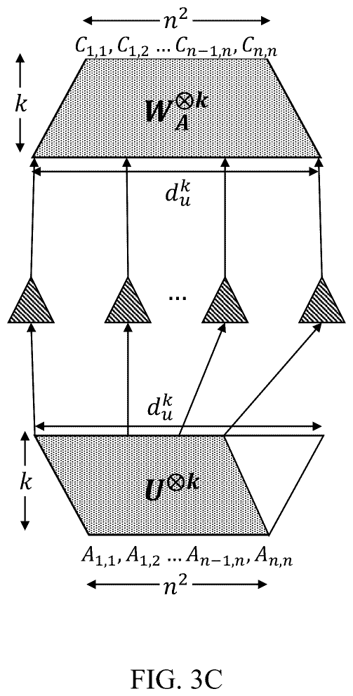

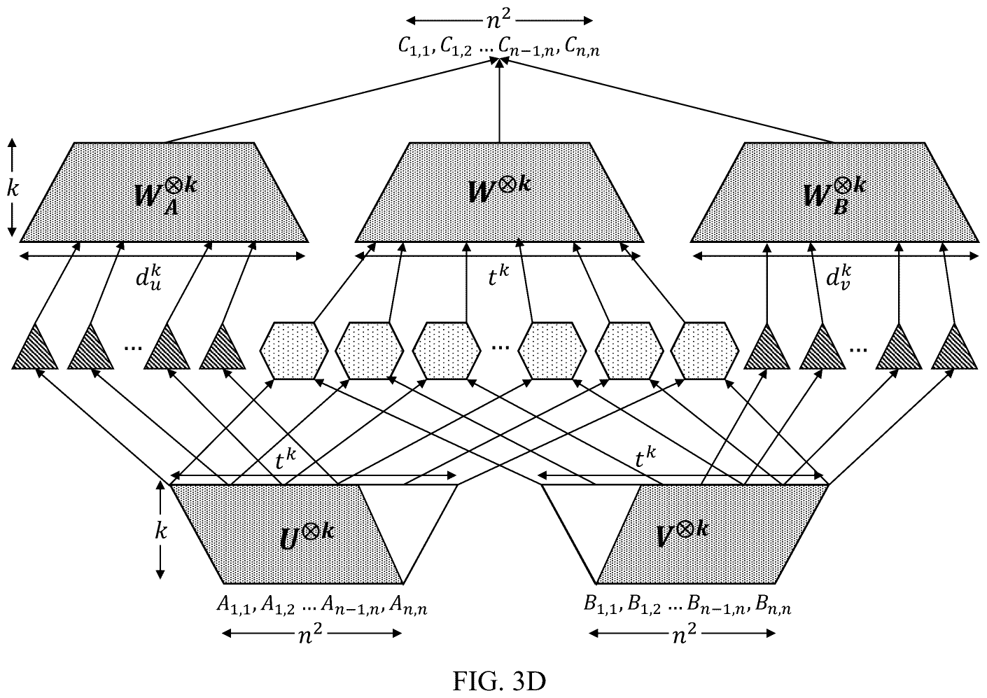

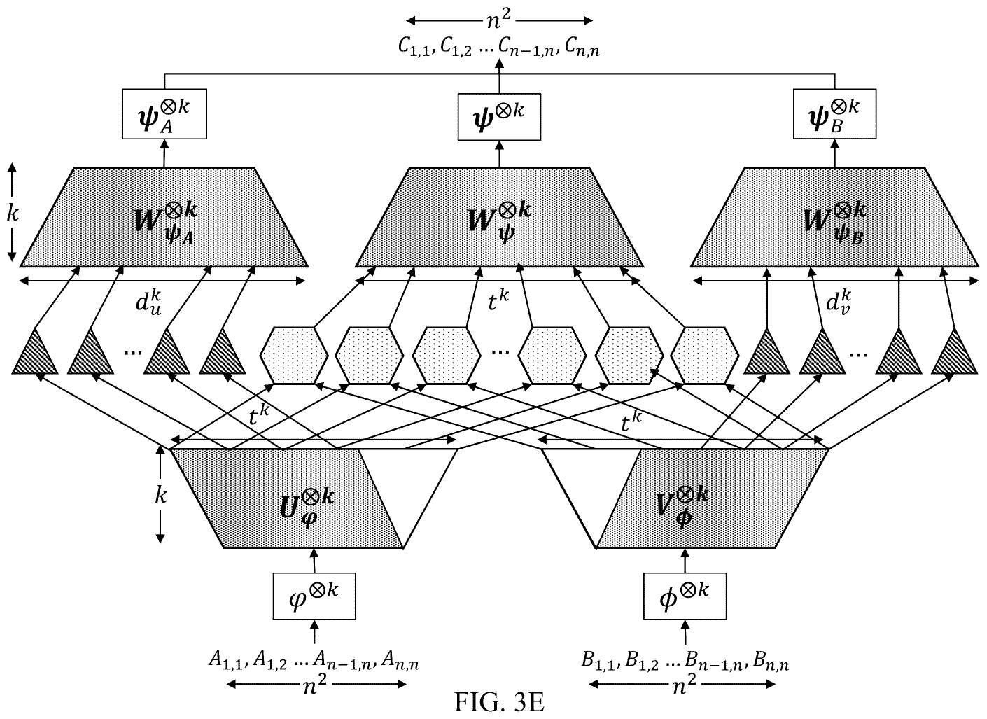

FIGS. 3A-3D illustrate the computation graphs of multiplying two n×n matrices using a fast recursive algorithm, then switching to b×b blocks multiplication using one of three base case algorithms:
FIG. 3A illustrates the existing hybrid fast matrix multiplication, switching to the classical algorithm on small blocks of size b×b. The hexagons represent the classical algorithm.
FIG. 3B Illustrates the algorithm in Winograd (1968). The hexagons stand for the folded classical algorithm, each using

$$\frac{{b}^{3}}{2}$$

multiplications. The triangles stand for the
correction terms, namely the

$$\frac{{b}^{2}}{2}$$

multiplications of the form aᵢ·aⱼ and the

$$\frac{{b}^{2}}{2}$$

of the form bᵢ·bⱼ. See Theorem 3.1 hereinbelow.
FIG. 3C illustrates the correction terms for the present algorithm. Each triangle uses

$$\frac{{b}^{2}}{2}$$

multiplications and returns a vector of length b.
FIG. 3D illustrates the present algorithm. As can be seen, the multiplications are divided into main multiplications and correction terms. Correction terms may then be used in multiple block multiplications, in order to save arithmetic operations.
FIG. 3E illustrates the present algorithm, wherein a basis transformation is applied to the input matrices, and an inversion of the basis transformation, as taught by U.S. Pat. No. 10,387,534 to Schwartz et al, the contents of which are incorporated herein by reference in their entirety.

In some embodiments, the present algorithm generalizes the algorithm in Winograd (1968), wherein the construction for multiplying n×n matrices is represented as shown below in Theorem 3.1.

Theorem 3.1: Let n be an even integer. There is a commutative algorithm that multiplies two n×n matrices using

$$\frac{{n}^{3}}{2} + {n}^{2}$$

multiplications and

$$\frac{3 {n}^{3}}{2} + 2 {n}^{2} - n$$

additions.

Proof idea: The algorithm is obtained by folding the classic algorithm. That is, it uses the identity a₁b₁+a₂b₂=(a₁+b₂) (a₂+b₁)−a₁a₂−b₁b₂. For every j ∈ [n], the classic algorithm contains the computation a₁₁b₁ⱼ+a₁₂b₂ⱼ. Using the folding identity, each of these computations uses the multiplication a₁₁a₁₂, so instead of computing it n times, one can compute it once. The same idea also works for the multiplications that use only elements from B.

Note that the classic algorithm is a non-commutative one. The present technique generalizes the folding technique in Winograd (1968) to general non-commutative algorithms. Let [symbol] U, V, W [symbol] be an (m, m, m; t [symbol] —algorithm such that U has dᵤ distinct rows and V has dᵥ distinct rows where dᵤ, dᵥ<t. Consider an algorithm ALG that has k recursive calls of (U, V, W), and then a single call to the algorithm in Winograd (1968) algorithm (FIG. 3B). This algorithm incurs considerable overhead compared to the classic algorithm (FIG. 3A) for small blocks.

As U has only dᵥ distinct rows, the combined algorithm multiplies the same sub-block of A by several sub-blocks of B. The algorithm may be improved by computing correction terms that depend on A only once. This improvement reduces the overhead significantly (see FIGS. 3C-3D).
Formal description: First, the present technique provides for generalizing the uniting-of-terms technique, to reduce the number of multiplications the algorithm uses. Then, the present technique provides for composing a non-commutative algorithm with a commutative one. Finally, the two methods are combined to obtain algorithms that use fewer arithmetic operations.
Claim 3.1: Let (U, V, W) be a bilinear algorithm that computes ƒ: Rⁿ×R^{m}→R^{k}, using t multiplications. If the last two rows of U and V are duplicate, namely Uₜ=Uₜ₋₁ and Vₜ=Vₜ₋₁, then the tensor

$$〈 {U}^{′} , {V}^{′} , {W}^{′} 〉 = 〈 ( \begin{matrix}{U}_{1} \\ ⋮ \\ {U}_{t - 1}\end{matrix} ) , ( \begin{matrix}{V}_{1} \\ ⋮ \\ {V}_{t - 1}\end{matrix} ) , ( \begin{matrix}{W}_{1} \\ ⋮ \\ {W}_{t - 1} + {W}_{t}\end{matrix} ) 〉$$

is equivalent to (U, V, W).

Claim 3.1 may be generalized to the commutative case and provide its effect on the number of linear operations.

Lemma 3.2: Let [symbol] U, V, W [symbol] be a commutative algorithm that computes ƒ: Rⁿ→R^{k}, using t multiplications and qᵤ, qᵥ, q_{w} linear operations in U, V, W respectively. If the last two rows of U and V are duplicate, namely Uₜ=Uₜ₋₁ and Vₜ=Vₜ₋₁, then the algorithm

$$〈 {U}^{′} , {V}^{′} , {W}^{′} 〉 = 〈 ( \begin{matrix}{U}_{1} \\ ⋮ \\ {U}_{t - 1}\end{matrix} ) , ( \begin{matrix}{V}_{1} \\ ⋮ \\ {V}_{t - 1}\end{matrix} ) , ( \begin{matrix}{W}_{1} \\ ⋮ \\ {W}_{t - 1} + {W}_{t}\end{matrix} ) 〉$$

is equivalent to [symbol] U, V, W [symbol] . Furthermore, q′ᵤ≤qᵤ, q′ᵥ≤qᵥ,q′_{w}≤q_{w}.
Proof: Deleting a row from U reduces nnz(U) without increasing nns(U), thus by claim 2.12—

$${{q}^{′}}_{u} = nnz ( {U}^{′} ) + nns ( {U}^{′} ) - ( t - 1 ) \leq nnz ( U ) + nns ( U ) - 1 - t + 1 = {q}_{u} .$$

The same argument shows that q′ᵥ≤qᵥ. As for W, merging rows does not increase nnz(W)+nns(W), therefore—

$${{q}^{′}}_{w} = nnz ( {W}^{′} ) + nns ( {W}^{′} ) - k \leq nnz ( W ) + nns ( W ) - k = {q}_{w} .$$

Note that any commutative algorithm for computing bilinear function can be represented as 3 separate algorithms: ALG_{A}, ALG_{B} and ALG_{AB}. ALG_{A} dependent only on the first part of the input, ALG_{B} dependent only on the second part of the input, these are the correction terms, and the main multiplications ALG_{AB} is dependent on both. After computing the three algorithms, they may be combined.
Definition 3.3: Let R be a commutative ring. The notation [symbol] x, y, z; t_{AB}, t_{A}, t_{B} [symbol] C is used to represent a commutative matrix multiplication algorithm of the dimensions [symbol] x, y, z [symbol] that uses t_{AB}+t_{A}+t_{B} multiplications where ALG_{A} uses t_{A} of them, ALG_{B} uses t_{B} of them, and ALG_{AB} uses the remaining t_{AB} multiplications.

The linear operations are similarly split to s=S_{AB}+S_{A}+S_{B}+S_{M}, where ALG_{AB} uses S_{AB} of them, S_{A}, S_{B} are defined similarly, and S_{M} is the number of additions needed to combine the three algorithms.
Example 3.4: Consider the following [symbol] 1,2,1; 1,1,1 [symbol] ^{C}—algorithm:

$${M}_{1} = ( {a}_{1} + {b}_{2} ) ( {a}_{2} + {b}_{1} )$$

$${M}_{2} = {a}_{1} {a}_{2}$$

$${M}_{3} = {b}_{1} {b}_{2}$$

$$c = {M}_{1} - {M}_{2} - {M}_{3}$$

M₁ is ALG_{AB}, M₂ is ALG_{A}, and M₃ is ALG_{B}. The last row combines the three algorithms. It may also be described by—

$$〈 U , V , W 〉 = 〈 ( \begin{matrix}1 & 0 & 0 & 1 \\ 1 & 0 & 0 & 0 \\ 0 & 0 & 0 & 1\end{matrix} ) , ( \begin{matrix}0 & 1 & 1 & 0 \\ 0 & 1 & 0 & 0 \\ 0 & 0 & 1 & 0\end{matrix} ) , ( \begin{matrix}1 \\ - 1 \\ - 1\end{matrix} ) 〉$$

In this algorithm, S_{AB}=2, S_{A}=S_{B}=0, and S_{M}=2. Note that Winograd (1968) uses this algorithm as a building block (see Theorem 3.1 above).
Definition 3.5: Let [symbol] U^{I}, V^{I}, W^{II}) be an (x, y, Z; T_{AB}, t_{A}, t_{B} [symbol] ^{C}—algorithm, and let (U^{O}, V^{O}, W^{O}) be an (a, b, c; t)—algorithm. Then the standard composition of (U^{O}, V^{O}, W^{O}) with (Uⁱ, Vⁱ, Wⁱ) is

(U^{O},V^{O},W^{O})⊙(Uⁱ,V^{I},W^{I})((U^{O},⊗U_{A}^{I},V^{O}⊗U_{B}^{I}),(U^{O}⊗V_{A}^{I},V^{O}⊗V_{B}^{I}),W^{O}⊗_{W}^{I})
Remark 3.6: The intuitive composition (U^{O}⊗U^{I}, V^{O}⊗V^{I}, W^{O} W^{I}) does not work. The width of the encoding matrices of a commutative algorithm is the size of the input−abxy+bcyz, but the width of U^{O}⊗U^{I} is ab (xy+yz).
Proof idea: U^{O} operates on A and V^{O} operates on B, so they affect only the corresponding parts of (U^{I}, V^{I}, W^{I}).
Notation 3.7: Let (U^{O}, V^{O}, W^{O}) be an (a, b, c; t)—algorithm. Denote by (U′, U′, W_{A}) the algorithm equivalent to (U^{O}, U^{O}, W^{O}) that Lemma 3.2 provides. Denote by q_{w}^{A} and q′ᵤ the number of linear operations used to apply W_{A} and U′ respectively. Similarly define q_{w}^{B} and q′ᵥ.

In some embodiments, the present technique provides for an improved composition algorithm termed herein COAT, which may be implemented based on exemplary Algorithm 2. FIG. 3D illustrates the computation graph of COAT. The main difference between COAT and the standard composition (Definition 3.5) is that the latter uses a black-box composition while COAT is more involved.
Theorem 3.2: Let [symbol] U^{O}, V^{O}, W^{O}) be an (m, m, m; t [symbol] —algorithm that uses q linear operations such that U^{O} has dᵥ distinct rows and V^{O}, has dᵥ distinct rows, and let (U^{I}, V^{I}, W^{I}) be a (b, b, b; t_{AB}, t_{A}, t_{B})^{C}—algorithm that uses S_{AB}+S_{A}+S_{B}+S_{M} linear operations. Let n=b·m^{k}, then Algorithm 2 is an (n, n, n; t^{k}·t_{AB}, dᵤ^{k}·t_{A}, dᵥ^{k}·t_{B})^{C}—algorithm that uses at most

$$( \frac{{qb}^{2}}{t - {m}^{2}} + {s}_{AB} ) {t}^{k} + O ( {d}_{u}^{k} + {d}_{v}^{k} )$$

linear operations.

Proof sketch: Claim 3.8 below may be used to compose (U^{O}, V^{O}, W^{O}) Ok with (U^{I}, V^{I}, W^{I}).
Claim 3.8: Let all the parameters be as Theorem 3.2. Then there is an (mb, mb, mb; t·t_{AB}, dᵤ·t_{A}, dᵥ·t_{B})^{C}—algorithm that uses at most ts_{AB}+dᵤ·S_{A}+dᵥ·S_{B}+(q+2qᵤ′+2qᵥ′+q+q_{w}^{A}+q_{w}^{B})b₂+m²s_{M} linear operations.

In some embodiments, the present technique provides for a commutative algorithm optimal for small blocks, termed herein commutative optimal algorithm for tiny blocks COAT. In some embodiments, COAT may be implemented based on exemplary Algorithm 2. Exemplary Algorithm 2 represents an improved composition of an (a, b, c; t) algorithm (U^{O}, V^{O}, W^{O}) recursively with an (x, y, z; t_{AB}, t_{A}, t_{B}) C algorithm that split into ALG_{A}^{I}, ALG_{B}^{I}, and ALG_{AB}^{I}. Define BFIX similarly to AFIX.

Algorithm 2:

| Input A ∈ R^{a}_{^{k}}^{x×b}_{^{k}}^{y}, B ∈ R^{b}_{^{k}}^{y×c}_{^{k}}^{z}, k ∈ [symbol] | | |
|---|---|---|
| Output C = A · B ∈ R^{a}_{^{k}}^{x×c}_{^{k}}^{z} | | |
| 1: | function COAT (A, B, k) | |
| 2: | C = RCA (A, B, k) | |
| 3: | A_{F} = AFIX (A, k) | |
| 4: | B_{F} = BFIX (B, k) | |
| 5: | return C + A_{F} + B_{F} | |
| 1: | function RCA (A, B, [symbol] ) | |
| 2: | if [symbol] = 0 then | |
| 3: | return ALG_{AB}¹(A, B) | |
| 4: | else | |
| 5: | Ã = U^{o} · Â | [symbol] transform the input (Notation 2.4) |
| 6: | \tilde{B} = V^{o} · \hat{B} | |
| 7: | for i = 1, . . . , t do | |
| 8: | \tilde{C}ᵢ = RCA(Ã_{I}, \tilde{B}_{I}, [symbol] − 1) | |
| 9: | return (W^{o})^{T} · \tilde{C} | [symbol] transform the output |

| | |
|---|---|
| 1: | function AFIX (A, [symbol] ) |
| 2: | if [symbol] = 0 then |
| 3: | return ALG_{A}¹(A) |
| 4: | else Ã = U′ · Â |
| 5: | for i = 1, . . . , t do |
| 6: | A′ᵢ = AFIX(Ãᵢ, [symbol] − 1) |
| 7: | return (W_{A})^{T} · A′ |

Proof: Let ALG′_{A}^{I}, ALG_{B}^{I}; and ALG_{AB}^{I} be the three parts of the inner algorithm. Then their encoding/decoding matrices correspond to rows from [symbol] U^{I}, V^{I}, W^{I} [symbol] . By Fact 2.5, without loss of generality

$$〈 {U}^{I} , {V}^{I} , {W}^{I} 〉 = 〈 ( {U}_{A}^{I} , {U}_{B}^{I} ) , ( {V}_{A}^{I} , {V}_{B}^{I} ) , {W}^{I} 〉 = 〈 ( \begin{matrix}{U}_{MA}^{I} & {U}_{MB}^{I} \\ {U}_{FA}^{I} & 0 \\ 0 & {U}_{FB}^{I}\end{matrix} ) , ( \begin{matrix}{V}_{MA}^{I} & {V}_{MB}^{I} \\ {V}_{FA}^{I} & 0 \\ 0 & {V}_{FB}^{I}\end{matrix} ) , ( \begin{matrix}{W}_{M}^{I} \\ {W}_{FA}^{I} \\ {W}_{FB}^{I}\end{matrix} ) 〉$$

where ((U_{MA}^{I}, U_{MB}^{I}), (V_{MA}^{I}, V_{MB}^{I}), W_{M}^{I}) are the encoding/decoding matrices of ALG_{AB}^{I}, ((U_{FA}^{I}, 0), (V_{MA}^{I}, 0), W_{FA}^{I}) are the encoding/decoding matrices of ALG_{A}^{I}, and ((0, U_{MB}^{I}), (0, V_{MB}^{I}), W_{FB}^{I}) are the encoding/decoding matrices of ALG_{B}^{I}. Composing (U^{O}, V^{O}, W^{O}) with (U^{I}, V^{I}, W^{II}) using claim 3.5 yields
[symbol] U^{O}⊗U_{A}^{I},V^{O}⊗U_{B}^{I}),(U^{O}⊗V_{A}^{I},V^{O}⊗V_{B}^{I}),W^{O}⊗W^{I}

[symbol]

Splitting this algorithm into the three algorithms ALG_{A}, ALG_{B} and ALG_{AB} in this order provides:
((U^{O}⊗U_{FA}^{I}, V^{O}⊗0), (U^{O}⊗V_{FA}^{I}, V^{O}⊗0), WOWFAI)
((U^{O}⊗0, V^{O}⊗U_{FB}^{I}), (U^{O}⊗0,V^{O} ⊗V_{FB}^{I}), W^{O}⊗W_{FB}^{I})
((U^{O}⊗U_{MA}^{I}, V^{O}⊗U_{MB}^{I}), (U^{O}⊗V_{MA}^{I}, V^{O}⊗V_{MB}^{I}), W^{O}⊗W_{M}^{I})

Note that ALG_{AB}=(U^{O}, V^{O}, W^{O}) ALG_{AB}. Therefore computing ALG_{AB} uses t·t_{AB} multiplications. It is possible to apply U^{O} and V^{O}, using (qᵤ+qᵥ)b² linear operations, apply ALG_{AB}^{I} to each of the t blocks using S_{AB} linear operations, and apply W^{O} to them using q_{w}b² linear operations. In total ALG_{AB} uses t·t_{AB} multiplications and qb²+tS_{AB} linear operations.

ALG_{A} uses only elements from A, so the columns that depend on B may be removed from the encoding matrices, meaning that—

$${ALG}_{A} = 〈 {U}^{O} ⊗ {U}_{FA}^{I} , {U}^{O} ⊗ {V}_{FA}^{I} , {W}^{O} ⊗ {W}_{FA}^{I} 〉 = 〈 {U}^{O} , {U}^{O} , {W}^{O} 〉 ⊗ {ALG}_{A}^{I}$$

By Lemma 3.2 there is an algorithm (U′, U′, W_{A}) equivalent to (U^{O}, U^{O}, W^{O}) that uses only dᵤ multiplications, and less linear operations than (U^{O}, U^{O}, W^{O}). Thus, replacing ALG_{A} with ALG_{A}′=(U′, U′, W_{A})⊗ALG_{A}^{I} provides the same result using fewer operations.

This improvement allows to compute the result of ALG_{A} using only dᵤt_{A} multiplications and (2qᵤ′+q_{w}^{A})b²+dᵤs_{B} linear operations. The same argument shows that computing the result of ALG_{B} takes dᵥ·t_{B} multiplications and at most (2qᵥ′+q_{w}^{B})b₂+dᵥS_{B} linear operations.

Given the results from all three algorithms, it is possible to compute the output using m²S_{M} additions. In total, t·t_{AB}+dᵤ·t_{A}+dᵥ·t_{B} multiplications were used, and at most tS_{AB}+dᵤ·S_{A}+dᵥ·S_{B}+m²S_{M}+(q+2qᵤ′+2qᵥ′+q_{w}^{A}+q_{w}^{B})b₂ linear operations
claim 3.9: Applying Algorithm 2 with Winograd's [symbol] 2,2,2; 4,2,2 [symbol] G-algorithm yields an algorithm that uses 4+o(1) scalar multiplications and 8+o(1) additions for each block multiplication.
Proof: By claim 3.8, Algorithm 2 contains the block multiplications and t_{AB}·t^{k}+0 (dᵤ^{k}+dᵥ^{k}) scalar multiplications. t_{AB}=4, thus the algorithm uses 4+o(1) scalar multiplications for each block multiplication. By Theorem 3.2, Algorithm 2 uses S_{AB}t^{k}+0 (dᵤ^{k}+dᵥ^{k}) linear operations outside the ones that are used for the recursive phase. By claim 3.8 and Example 3.4, S_{AB}=4. 2=8. Therefore, Algorithm 2 uses 8+o(1) additions for each block multiplication.

### Lower Bounds and Optimality

In some embodiments, the present technique provides for obtaining commutative algorithms from non-commutative ones, by folding the multiplications. In some embodiments, the present technique uses the inverse operation to provide lower bounds for commutative algorithms, by unfolding commutative multiplications, which can reduce the total number of operations.
Definition 3.10: ALG′ may be said to be an unfolding of ALG, or ALG may be said to unfold to ALG′, if replacing each multiplication of the form (A₁+B₂) (A₂+B₁) in ALG with A₁B₁+A₂B₂ results in ALG′.
Theorem 3.3: Let ALG be an [symbol] l, m, n; t_{AB}, t_{A}, t_{B} [symbol] ^{C}—algorithm. Let algorithm be an unfolding of ALG. Then ALG′ is an [symbol] l, m, n; 2t_{AB} [symbol] —algorithm that uses no more arithmetic operations than ALG.
Proof: Recall that the correction terms are multiplications that depend only on one of the matrices. Let A₁·A₂ be a correction term. The unfolding of this multiplication is A₁·0+A₂·0=0. Therefore the correction terms do not affect ALG′. Inspect the effect of unfolding on a given multiplication from ALG_{AB}. It is of the form (A₁+B₂) (A₂+B₁). This row may thus be applied without commutativity using A₁B₁+A₂B₂ instead, since A₁A₂ and B₁B₂ do not appear in the result. Thus there is obtained an [symbol] l, m, n; 2t_{AB} [symbol] —algorithm.

Note that if at least one of the four elements A₁, A₂, B₁, B₂ is zero, then A₁B₁+A₂B₂ consists of only one multiplication. In this case, the unfolding saves additions without increasing the number of multiplications. If all of A₁, A₂, B₁, B₂ are non-zeroes, then the unfolding trades one addition for one multiplication. Hence the total amount of arithmetic operations remains unchanged.
Theorem 3.3 seems to imply that commutative algorithms cannot improve the running time relative to non-commutative algorithms. However, scalar multiplication often costs more than an addition, so the correct lower bound is the one of Corollary 3.11:
Corollary 3.11: Assume that a scalar multiplication costs as much as p additions. Then no commutative algorithm can improve the run time of a non-commutative algorithm that uses t multiplications and q linear operations by a factor larger than

$$\frac{\frac{ρ + 1}{2} t + q}{t ρ + q} .$$

Proof: Let ALG be an [symbol] l, m, n; t [symbol] algorithm that uses q linear operations. Let ALG′ be an (l, m, n; t_{AB}, t_{A}, t_{B})^{C}—algorithm that unfolds to ALG. By Theorem 3.3, ALG′ uses at least t+q operations and at most 2t_{AB} multiplications. Therefore, ALG′ uses at least

$$\frac{t}{2}$$

multiplications. Since ρ≥1, the arithmetic cost of computing ALG′ is at least

$$ρ \frac{t}{2} + t + q - \frac{t}{2} = \frac{ρ + 1}{2} t + q .$$

On the other hand, the arithmetic cost of computing ALG is tρ+q. The lower bound on the costs ratio follows.

It may be concluded that if the classic algorithm is the optimal non-commutative algorithm for a specific size, then COAT with the algorithm in Winograd (1968) is the optimal commutative algorithm for sub-blocks of the same size. This algorithm may be termed a generalized folded algorithm (GFA).
Theorem 3.11: Let n ∈ [symbol] be an even integer. Assume the classical (n, n, n; n³)—algorithm has the lowest arithmetic cost among all (n, n, n; t)—algorithms. Then GFA has the lowest arithmetic cost among all commutative algorithm for computing sub-blocks of dimensions (n, n, n) up to a low order term if dᵤ, dᵥ<t in the outer algorithm.
Proof: Assume that, for a fixed n, the classical algorithm has the lowest arithmetic cost among all (n, n, n; t)—algorithms. Then the lower bound of Theorem 3.11 is the lowest when applying it to the classical algorithm. Setting t=n³ and q=n³−n², with may be deduced that any commutative algorithm for multiplying n×n blocks costs at least

$$\frac{ρ + 1}{2} {n}^{3} + {n}^{3} - {n}^{2} = \frac{ρ + 3}{2} {n}^{3} - {n}^{2} .$$

By Corollary 4.2, the arithmetic cost of multiplying each pair of blocks using GFA is—

$$\frac{\frac{ρ {n}^{3} {t}^{k}}{2} + ( \frac{3 {n}^{3}}{2} - {n}^{2} ) {t}^{k} + O ( {d}_{u}^{k} + {d}_{v}^{k} ) {n}^{2}}{{t}^{k}} = \frac{ρ + 3}{2} {n}^{3} - {n}^{2} + O ( \frac{{d}_{u}^{k} + {d}_{v}^{k}}{{t}^{k}} {n}^{2} )$$

which, when dᵤ, dᵥ<t, is only slightly larger than the lower bound of

$$\frac{ρ + 3}{2} {n}^{3} - {n}^{2} .$$

### Tight Bounds For 2×2 Multiplication

GFA multiplies 2×2 blocks using 4+o(1) multiplications and 8+o(1) additions. Matching lower bounds may be demonstrated both for multiplications and additions. Note that the existing lower bounds for commutative matrix multiplication implicitly assume that the multiplication is not part of a recursive multiplication of larger matrices. The present bounds do not make this assumption and therefor hold for sub-block multiplication.

It is only assumed that the algorithm is homogenous, namely, that the same algorithm is used for all block multiplications, and that every main multiplication impacts only one block multiplication.
Theorem 3.4: Every algorithm for multiplying two 2×2 matrices requires at least 7 multiplications.
Theorem 3.5: Every homogenous commutative algorithm for multiplying 2×2 blocks requires at least 4 scalar multiplications.
Proof: By Theorems 3.4 and 3.3, any 2×2 block multiplication algorithm requires at least 3.5 multiplications. Each block multiplication uses the same number of multiplications, so the amortized cost of all the block multiplications must be integral. The lower bound follows.

Given this tight lower bound on the number of multiplications, a lower bound on the number of linear operations may be demonstrated.
Claim 3.12: Every commutative algorithm for multiplying 2×2 blocks must use at least 12 arithmetic operations.
Theorem 3.6: Any non-commutative algorithm that multiplies 2×2 blocks using 7 multiplications requires at least 12 linear operations.
Proof of claim 3.12: 2×2 arithmetic cost lower bound. By Theorem 3.2, it suffices to show that claim 3.12 holds for non-commutative algorithms. Let ALG= [symbol] U, V, W [symbol] be a non-commutative algorithm to multiply 2×2 blocks using t multiplications. If t=7, then by Theorem 3.2.1, ALG uses at least 12+7=19 arithmetic operations.

Assume that t≥8. Each row of W has a non-zero, so there are at least t non-zeros in W. W has 4 columns, so applying it takes at least t−4 linear operations. We conclude that ALG requires at least t+t−4≥2. 8−4=12 arithmetic operations.

### Applications

Recall the [symbol] 1,2,1; 1,1,1 [symbol] ^{C}—algorithm we saw in Example 3.4:

$$ALG = 〈 U , V , W 〉 = 〈 ( \begin{matrix}1 & 0 & 0 & 1 \\ 1 & 0 & 0 & 0 \\ 0 & 0 & 0 & 1\end{matrix} ) , ( \begin{matrix}0 & 1 & 1 & 0 \\ 0 & 1 & 0 & 0 \\ 0 & 0 & 1 & 0\end{matrix} ) , ( \begin{matrix}1 \\ - 1 \\ - 1\end{matrix} ) 〉$$

ALG is the primary building block in the algorithm in Winograd (1968). In fact,

for any x, y, z ∈ [symbol] , Winograd's

$${〈 x , y , z ; \frac{x y z}{2} , \frac{x y}{2} , \frac{y z}{2} 〉}^{C}$$

algorithm is a modification on composing the classic

$$〈 x , \frac{y}{2} , z ; \frac{xyz}{2} 〉$$

algorithm with ALG using the results detailed hereinabove. In some embodiments, the present technique provides for an algorithm which uses composes a general [symbol] x, y, z; t [symbol] algorithm with ALG.

### Arithmetic Complexity

claim 4.1: Let b ∈ [symbol] be even. There is an

$${〈 b , b , b ; \frac{{b}^{3}}{2} , \frac{{b}^{2}}{2} , \frac{{b}^{2}}{2} 〉}^{C}$$

—algorithm that uses

$$\frac{3}{2} {b}^{3} + 2 {b}^{2} - 2 b$$

linear operations.
Corollary 4.2: (GFA) Let b, k ∈ [symbol] where b is even and let [symbol] U,V, W [symbol] be an [symbol] m, m, m; t [symbol] —algorithm that uses q linear operations. Denote n=bm^{k} and assume that U, V have dᵤ,dᵥ distinct rows, respectively. Then applying GFA gives an

$${〈 n , n , n ; \frac{{b}^{3}}{2} {t}^{k} , \frac{{b}^{2}}{2} {d}_{u}^{k} , \frac{{b}^{2}}{2} {d}_{v}^{k} 〉}^{C}$$

—algorithm that uses

$$( \frac{{qb}^{2}}{t - {m}^{2}} + \frac{3}{2} {b}^{3} - {b}^{2} ) {t}^{k} + O ( {d}_{u}^{k} + {d}_{v}^{k} )$$

linear operations.
Proof: Immediate from Theorem 3.2 and claim 4.1.
Remark 4.3: Composing the same outer algorithm with the classic (b, b, b; x³)—algorithm, instead of GFA, results in an [symbol] n, n, n; b³t^{k} [symbol] —algorithm that uses

$$( \frac{{qb}^{2}}{t - {m}^{2}} + {b}^{3} - {b}^{2} ) {t}^{k} + O ( {n}^{2} )$$

linear operations.

### Communication Costs

This section shows that the communication cost of the GFA algorithm is the same, up to a low order term, as the HYB algorithm, (the conventional hybrid fast matrix multiplication algorithm switching to the classical one at the same cutoff point). This holds both in the sequential and the parallel models. To this end, there is used a reduction from the main multiplications of GFA to the classic algorithm. It is then proven that the correction phase uses asymptotically less communication (smaller by a factor of

$$\frac{{d}_{u}^{k} + {d}_{v}^{k}}{{t}^{k}} ) .$$

Note that it is possible to completely avoid inter-processor I/O-complexity overhead by using the standard composition (claim 3.5) until the blocks fit a single processor's memory, and then switch to COAT. This change slightly increases the I/O and the arithmetic complexity by reducing k.

Algorithm 2 is used in both models (sequential and parallel). First, the main multiplications are computed, then the correction terms, and finally the results are combined. It is assumed that the parameters are the same as in Corollary 4.2. Namely, b, k ∈ [symbol] where the block size b is even, [symbol] U, V, W [symbol] is an [symbol] m, m, m; t [symbol] —algorithm, and U, V have dᵤ, dᵥ distinct rows respectively.
Parallel model: In order to minimize the inter-processor communication costs of GFA, two different parallelization methods are used. For RCA, the same parallelization technique is used as the one in HYB, to keep the I/O-complexity from changing. As for AFIX and BFIX, the BFS-DFS parallelization technique is used, to give an upper bound on their I/O-complexity.

### Theorem 4.1:

$${IO}_{GFA} ( P , M , {m}^{k} , b ) = ( 1 + o ( 1 ) ) {IO}_{HYB} ( P , M , {m}^{k} , b )$$

To prove Theorem 4.1, its three components are analyzed separately (recall Algorithm 2). Lemma 4.4 shows that the I/O-complexity of RCA is the same as that of HYB. Lemma 4.6 proves that AFIX and BFIX use asymptotically less communication.
Lemma 4.4: Let MAIN be the main multiplications in one block of GFA. If

$${IO}_{CLS} ( P , M , b ) = α \frac{{b}^{3}}{P \sqrt{M}} + {β ( \frac{{b}^{3}}{P} )}^{\frac{2}{3}} + γ {b}^{2} + δ M .$$

Then IO_{MAIN}(P, M, b)≤10_{CLS}(P,M,b).
Proof: A, B, and C are treated as if each block of size 2×2 is a single element. This reduces x by a factor of 2, M by a factor of 4, and increases the cost of sending an element by a factor of 4. Then, the classical algorithm is used to obtain—

$${IO}_{MAIN} ( P , M , b ) \leq 4 \cdot {IO}_{CLS} ( \frac{M}{4} , P , \frac{b}{2} ) \leq 4 ( α \frac{{b}^{3}}{4 P \sqrt{M}} + {β ( \frac{{b}^{3}}{8 P} )}^{\frac{2}{3}} + γ \frac{{b}^{2}}{4} + δ \frac{M}{4} ) = {IO}_{CLS} ( P , M , b )$$

Lemma 4.5:

$${IO}_{AFIX} ( M , P , 1 , b ) = O ( \frac{{b}^{2}}{P} )$$

Proof: Note that the correction terms of A are μ=(A^{e}⊙A^{O})·1 where 1 is the all-ones vector. First, reorganize the elements of A such that each processor has

$$\frac{P}{b}$$

rows. Then, each processor computes locally the corresponding elements from μ. Finally, if some rows are split, the processors sum their data.

The first step requires at most

$$O ( \frac{{b}^{2}}{P} )$$

communication. The second step does not require communication. The third step uses at most

$$O ( \frac{b}{P} )$$

communication since there are b elements μ (it is a vector). In total, this algorithm used

$$O ( \frac{{b}^{2}}{P} )$$

communication.

Next, an upper bound on the I/O-complexity of AFIX is shown, the same analysis shows that BFIX also uses o(10_{HYB}(P, M, m^{k}, b)).
Lemma 4.6: 10_{AFIX}(P, M, m^{k}, b)=o(10_{HYB}(P, M, m^{k}, b)).
Proof: AFIX performs k recursive steps before computing u. First, consider the case where b²≤M, namely an entire sub-block fits into one processor's local memory. Computing μ does not affect the I/O-complexity. Therefore an analysis shows that

$${IO}_{AFIX} ( P , M , {m}^{k} , b ) = O ( \frac{M}{P} {( \frac{{bm}^{k}}{\sqrt{M}} )}^{{log}_{a} {d}_{u}} + \frac{{b}^{2} {m}^{2 k}}{{P}^{\frac{2}{{log}_{m} {d}_{u}}}} ) .$$

Otherwise (if b²>M), all processors are utilized to compute the dᵥ recursive calls to block multiplications of size bm^{k-1}×bm^{k-1}. When the algorithm reaches the base case, a sub-block of size b×b, by Lemma 4.5, computing u takes

$$O ( \frac{{b}^{2}}{P} )$$

communication. Thus,

$${IO}_{AFIX} ( P , M , {m}^{k} , b ) = \{ \begin{matrix}O ( \frac{{b}^{2}}{P} ) & ifk = 0 \\ {d}_{u} {IO}_{AFIX} ( M , P , {m}^{k - 1} , b ) & otherwise\end{matrix}$$

Thus,

$${IO}_{AFIX} ( P , M , {m}^{k} , b ) = O ( {d}_{u}^{k} \cdot \frac{{b}^{2}}{P} ) .$$

By claim 4.7, in both cases 10_{AFIX}(P, M, m^{k}, b)=o(10_{HYB}(P, M, m^{k}, b)).

$$\begin{matrix}Claim 4.7 & \\ I {O}_{HYB} ( P , M , {m}^{k} , b ) = Ω ( {( \frac{{bm}^{k}}{max ( b , \sqrt{M} )} )}^{{log}_{m} t} \frac{max ( \frac{{b}^{3}}{\sqrt{M}} , M )}{P} + \frac{{b}^{2} {m}^{2 k}}{{P}^{\frac{2}{{log}_{m} t}}} ) & \end{matrix}$$

Proof of Theorem 4.1: Let FIX denote computing both AFIX and BFIX. Now, by Lemma 4.4 and Lemma 4.6,

$$I {O}_{GFA} ( P , M , {m}^{k} , b ) = I {O}_{RCA} ( P , M , {m}^{k} , b ) + I {O}_{FIX} ( P , M , {m}^{k} , b ) = ( 1 + o ( 1 ) ) I {O}_{HYB} ( P , M , {m}^{k} , b )$$

### The Sequential Model

$$\begin{matrix}Theorem 4.2 & \\ I {O}_{GFA} ( M , {m}^{k} , b ) = ( 1 + o ( 1 ) ) I {O}_{HYB} ( M , {m}^{k} , b ) . & \end{matrix}$$

The analysis is practically the same as in the parallel model, plugging in P=1 and skipping the memory independent case.

### Calculating Multi-Linear Functions

In some embodiments, the present technique provides for an algorithm configured for reducing the computational cost of calculating a multi-linear function multiple times. In some embodiments, the present algorithm is optimized for cases in which at least one component of the inputs is known in advance and remains constant (denoted A), and the others change between calls (denoted B). In some embodiments, the present algorithm works in three stages:
(i) Search: Identify suitable (optionally commutative) algorithm.
(ii) Split: Given the algorithm, separate the preprocessing part from the part that requires the entire input.
(iii) Application: Compute the preprocessing part in advance, and then the rest of the algorithm when needed.

The application part uses a commutative algorithm to compute the same function as the non-commutative it replaces, while saving resources (time, energy or hardware). It works as follows:
(a) Compute in advance the parts of the commutative algorithm that depends on A only.
(b) Upon receiving B, compute the rest of the algorithm.

A suitable algorithm in this context is one which minimizes the computational resources of computing step (b) above, regardless of the costs incurred by step (a). Any such algorithm must also satisfy the multi-linear equations that define the desired function to calculate.

Once a suitable new algorithm is found, it can be improved by separating the preprocessing part from the part that requires the entire input. In the splitting process, the present algorithm identifies all computations that can be performed in advance, and decide to which part each one belongs.

For example, the present technique improves any algorithm that multiplies the same matrix A with many matrices, by computing the correction terms of A in advance. Then, when computing the multiplications, all that is requires is to compute the main multiplications and the correction terms of B. This scenario happens in several use cases, such as the multiple-input and multiple-output (MIMO) method for radio communication.

The method can be applied to multi-linear algorithms. Two examples are provided for multiplying a known k×k matrix with multiple vectors. The first example uses the algorithm from Winograd (1968) algorithm and is faster than using the classical matrix multiplication when

$$ρ > 1 + ( \frac{8 k - 5}{{k}^{2} - 2 k} ) .$$

The second example is a commutative

$$〈 1 , k , k ; \frac{k ( k + 1 )}{2} , 0 , \frac{k ( k - 1 )}{2} 〉$$

—algorithm that generalizes the algorithm from Rosowski (see, Andreas Rosowski. 2019. Fast Commutative Matrix Algorithm. arXiv preprint arXiv: 1904.07683 (4 2019)), and is faster than the classical algorithm when

$$ρ > 2 + \frac{6 k - 2}{k ( k - 1 )} .$$

### Using Rosowski's Algorithm

In some embodiments, the present technique provides for a new algorithm that generalizes Rosowski's algorithm, and is configured for multiplying a matrix of size k×k with multiple vectors. This algorithm does not have correction terms that depend on the vectors, only on the matrix.

$$\begin{matrix}Search Stage & \\ For every 1 \leq i < j \leq k define {p}_{i , j} = ( {a}_{i} + {b}_{i , j} ) ( {a}_{j} + {b}_{j , i} ) , {p}_{j , i} = {b}_{i , j} \cdot {b}_{j , i} & \end{matrix}$$

$$and$$

$${p}_{i , j} = {a}_{i} \cdot ( {b}_{i , i} - {\sum }_{j \neq i} ( {b}_{j , i} + {a}_{j} ) ) .$$

$$Now {C}_{i} = {p}_{i , i} + {\sum }_{j = 1}^{i - 1} ( {p}_{j , i} - {p}_{i , j} ) + {\sum }_{j = i + 1}^{k} ( {p}_{i , j} - {p}_{j , i} ) .$$

Split Stage: (Preprocessing) compute bᵢⱼ=b_{i,i}−Σ_{j≠i} b_{j,i}, Cᵢ=Σⱼ₌₁ⁱ⁻¹ p_{j,i}+Σⱼ₌ᵢ₊₁^{k} p_{i,j}. Computing bᵢᵢ takes k·(k−1) additions, computing Cᵢ takes

$$\frac{k ( k - 1 )}{2}$$

multiplications and k (k−2) additions.
Application Stage: Compute p_{i,j}=(aᵢ+b_{i,j})(aⱼ+b_{j,i}), p_{i,i}=aᵢ·(b_{i,i}+aᵢ−x), x=Σᵢ₌₁^{k} aᵢ and now Cᵢ=Cᵢ+p_{i,i}−Σⱼ₌₁ᵢ₋₁^{k} P_{i,j}−Σⱼ₌ᵢ₊₁^{k} P_{j,i}. Computing p_{i,j} takes

$$\frac{k ( k + 1 )}{2}$$

multiplications and k (k+1) additions, computing x takes k−1 additions and computing Cᵢ takes k (k−1) additions. In total, the algorithm takes

$$\frac{k ( k + 1 )}{2}$$

multiplications and 2k²+k−1 additions.

### Winograd's Algorithm

Search Stage: Define μ=Σᵢ₌₁^{|k2|}a₂ᵢ₋₁a₂ᵢ, and for every 1≤j≤k define νⱼ=Σᵢ₌₁^{|k2|}b_{2i-1,j}b_{2i,j}. Now in the even case Cⱼ=Σᵢ₌₁^{k2}(a₂ᵢ+b_{2i-1,j})(a₂ᵢ₋₁+b_{2i,j})−μνⱼ, and in the odd case, Cⱼ=Σᵢ₌₁^{(k-1)2}(a₂ᵢ+b_{2i-1,j})(a₂ᵢ₋₁+b_{2i,j})−μ−νⱼ+aₖb_{k,j}.
Split Stage: (Preprocessing) compute νⱼ=−Σᵢ₌₁^{|k2|}b_{2i-1,j}b_{2i,j}. Computing it takes

$$k ⌊ \frac{k}{2} ⌋$$

multiplications and

$$k \cdot ( ⌊ \frac{k}{2} ⌋ - 1 )$$

additions.
Application Stage: Compute μ=Σᵢ₌₁^{|k2|}a₂ᵢ₋₁a₂ᵢ. In the even case, compute Cⱼ=Σᵢ₌₁^{k2}(a₂ᵢ+b_{2i-1,j})(a₂ᵢ₋₁+b_{2i,j})−μ−νⱼ, and in the odd case, compute Cⱼ=Σᵢ₌₁^{(k-1)2}(a₂ᵢ+b_{2i-1,j})(a₂ᵢ₋₁+b_{2i,j})−μνⱼ+aₖb_{k,j}. Computing μ takes

$$⌊ \frac{k}{2} ⌋$$

multiplications and

$$⌊ \frac{k}{2} ⌋ - 1$$

additions. multiplications and additions.
In the even case, computing Cⱼ takes

$$\frac{{k}^{2}}{2}$$

multiplications and

$$k ( \frac{3}{2} k + 1 )$$

additions
That is,

$$\frac{k ( k + 1 )}{2}$$

multiplications and

$$\frac{3 {k}^{2} + k - 2}{2}$$

additions in total.
In the odd case Cⱼ takes

$$\frac{k ( k + 1 )}{2}$$

multiplications and

$$k ( \frac{3}{2} k + \frac{1}{2} )$$

additions.
That is

$$\frac{{k}^{2} + 2 k - 1}{2}$$

multiplications and

$$\frac{3 {k}^{2} + 2 k - 5}{2}$$

additions in total.

### Comparison

Even case: In the even case, Winograd's algorithm uses the same number of multiplications, and fewer additions then the Rosowski's algorithm. The classic algorithm uses k² multiplications and k²−k additions. Thus Winograd's algorithm is better when

$$ρ \frac{{k}^{2} - k}{2} > \frac{{k}^{2}}{2} + \frac{3}{2} k - 1 ⇐ ρ > \frac{{k}^{2} + 3 k - 2}{{k}^{2} - k} = 1 + \frac{4 k - 2}{{k}^{2} - k} .$$

Odd case: The present algorithm is better than Winograd's when

$$\frac{ρ k}{2} > \frac{{k}^{2}}{2} - k + \frac{3}{2} ⇐ ρ > \frac{{k}^{2} - 2 k + 3}{k} = k - 2 + \frac{3}{k} .$$

The classic algorithm uses k₂ multiplications and k₂−k additions. Thus the present algorithm is better when

$$\frac{ρ k ( k - 1 )}{2} > {k}^{2} + 2 k - 1 ⇐ ρ > \frac{2 {k}^{2} + 4 k - 2}{k ( k - 1 )} = 2 + \frac{6 k - 2}{k ( k - 1 )} .$$

Combining these bounds show that the present algorithm is the best of the three for:

$$k = 3 , ρ \geq 4 \frac{2}{3} .$$

$$k > 3 , ρ \geq k - 2 + \frac{3}{k} > k - 2 .$$

Winograd's algorithm is better than the classical one when

$$ρ ( \frac{{k}^{2}}{2} - k ) > \frac{{k}^{2}}{2} + 3 k - \frac{5}{2} ⇐ ρ > \frac{{k}^{2} + 6 k - 5}{{k}^{2} - 2 k} = 1 + \frac{8 k - 5}{{k}^{2} - 2 k} .$$

That is, Winograd's algorithm is the best when

$$k \geq 5$$

$$and$$

$$1 + \frac{8 k - 5}{{k}^{2} - 2 k} \leq ρ \leq k - 2 + \frac{3}{k} .$$

In all other cases, the classic algorithm is the best one.

### Generalized Trilinear Condition

The main intuition to this theorem is that multiplications of the form A_{i,j}·A_{k,l} zero out in the final result. The same goes for B. When unfolding the multiplications and using the commutativity, the result should arrive at Brent's trilinear condition (see, Richard P. Brent. 1970. Algorithms for matrix multiplication. Technical Report. Stanford University, CA. Department of computer science.).
Proof of claim 2.14: For every s ∈ [t] denote—

$${M}_{s}^{L} = ( {\sum }_{{i}_{1} = 1}^{x} {\sum }_{{j}_{1} = 1}^{y} {U}_{s , ( {i}_{1} , {j}_{1} )}^{A} {A}_{{i}_{1} , {j}_{1}} + {\sum }_{{j}_{2} = 1}^{y} {\sum }_{{k}_{1} = 1}^{z} {U}_{s , ( {j}_{2} , {k}_{1} )}^{B} {B}_{{j}_{2} , {k}_{1}} )$$

$${M}_{s}^{R} = ( {\sum }_{{i}_{1} = 1}^{x} {\sum }_{{j}_{1} = 1}^{y} {U}_{s , ( {i}_{1} , {j}_{1} )}^{A} {A}_{{i}_{1} , {j}_{1}} + {\sum }_{{j}_{2} = 1}^{y} {\sum }_{{k}_{1} = 1}^{z} {U}_{s , ( {j}_{2} , {k}_{1} )}^{B} {B}_{{j}_{2} , {k}_{1}} )$$

$$Let \overline{{C}_{i , k}} = {\sum }_{s = 1}^{t} {W}_{s , ( i , k )} {M}_{s}^{L} {M}_{s}^{R} , then -$$

$$\overline{{C}_{i , k}} = {\sum }_{{i}_{1} = 1}^{x} {\sum }_{{i}_{2} = 1}^{x} {\sum }_{{j}_{1} = 1}^{y} {\sum }_{{j}_{2} = 1}^{y} ( {\sum }_{s = 1}^{t} {U}_{s , ( {i}_{1} , {j}_{1} )}^{A} {V}_{s , ( {i}_{2} , {j}_{2} )}^{A} {W}_{s , ( i , k )} ) {A}_{{i}_{1} , {j}_{1}} {A}_{{i}_{2} , {j}_{2}} + {\sum }_{{j}_{1} = 1}^{y} {\sum }_{{j}_{2} = 1}^{y} {\sum }_{{k}_{1} = 1}^{z} {\sum }_{{k}_{2} = 1}^{z} ( {\sum }_{s = 1}^{t} {U}_{s , ( {j}_{1} , {k}_{1} )}^{B} {V}_{s , ( {j}_{2} , {k}_{2} )}^{B} {W}_{s , ( i , k )} ) {B}_{{j}_{1} , {k}_{1}} {B}_{{j}_{2} , {k}_{2}} + {\sum }_{{i}_{1} = 1}^{x} {\sum }_{{j}_{1} = 1}^{y} {\sum }_{{j}_{2} = 1}^{y} {\sum }_{{k}_{1} = 1}^{z} {A}_{{i}_{1} , {j}_{1}} \text{} {B}_{{j}_{2} , {k}_{1}} \cdot ( {\sum }_{s = 1}^{t} {U}_{s , ( {i}_{1} , {j}_{1} )}^{A} {U}_{s , ( {j}_{2} , {k}_{1} )}^{B} {W}_{s , ( i , k )} + {U}_{s , ( {i}_{1} , {j}_{1} )}^{A} {V}_{s , ( {j}_{2} , {k}_{1} )}^{B} {W}_{s , ( i , k )} )$$

If for every i₁, i₂, i₃ ∈ [x], j₁, j₂ ∈ [y], k₁, k₂, k₃ ∈ [z] it holds that—

$${\sum }_{s = 1}^{t} ( {U}_{s , ( {i}_{1} , {j}_{1} )}^{A} {V}_{s , ( {j}_{2} , {k}_{1} )}^{B} + {U}_{s , ( {j}_{2} , {k}_{1} )}^{B} {V}_{s , ( {i}_{1} , {j}_{1} )}^{A} ) {W}_{s , ( {i}_{2} , {k}_{2} )} = {δ}_{{i}_{1} , {i}_{2}} \cdot {δ}_{{j}_{1} , {j}_{2}} \cdot {δ}_{{k}_{1} , {k}_{2}}$$

$${\sum }_{s = 1}^{t} {U}_{s , ( {i}_{1} , {j}_{1} )}^{A} {V}_{s , ( {i}_{2} , {j}_{2} )}^{A} {W}_{s , ( {i}_{3} , {k}_{1} )} = 0$$

$${\sum }_{s = 1}^{t} {U}_{s , ( {j}_{1} , {k}_{1} )}^{B} {V}_{s , ( {j}_{2} , {k}_{2} )}^{B} {W}_{s , ( {i}_{1} , {k}_{3} )} = 0$$

then direct computation shows C̅_̅{̅i̅,̅k̅}̅=Σⱼ₌₁^{y} A_{i,j}B_{j,k}=C_{i,k}.

If C̅_̅{̅i̅,̅k̅}̅=C_{i,k}=Σⱼ₌₁^{y} A_{i,j}B_{j,k} then—

$$\begin{matrix}0 = {\sum }_{{i}_{1} = 1}^{x} {\sum }_{{i}_{2} = 1}^{x} {\sum }_{{j}_{1} = 1}^{y} {\sum }_{{j}_{2} = 1}^{y} ( {\sum }_{s = 1}^{t} {U}_{s , ( {i}_{1} , {j}_{1} )}^{A} {V}_{s , ( {i}_{2} , {j}_{2} )}^{A} {W}_{s , ( i , k )} ) {A}_{{i}_{1} , {j}_{1}} {A}_{{i}_{2} , {j}_{2}} \\ = {\sum }_{{j}_{1} = 1}^{y} {\sum }_{{j}_{2} = 1}^{y} {\sum }_{{k}_{1} = 1}^{z} {\sum }_{{k}_{2} = 1}^{z} ( {\sum }_{s = 1}^{t} {U}_{s , ( {j}_{1} , {k}_{1} )}^{B} {V}_{s , ( {j}_{2} , {k}_{2} )}^{B} {W}_{s , ( i , k )} ) {B}_{{j}_{1} , {k}_{1}} {B}_{{j}_{2} , {k}_{2}}\end{matrix}$$

but different i's, j's and k's cannot cancel each other, so—

$$\begin{matrix}0 = ( {\sum }_{s = 1}^{t} {U}_{s , ( {i}_{1} , {j}_{1} )}^{A} {V}_{s , ( {i}_{2} , {j}_{2} )}^{A} {W}_{s , ( i , k )} ) {A}_{{i}_{1} , {j}_{1}} {A}_{{i}_{2} , {j}_{2}} \\ = ( {\sum }_{s = 1}^{t} {U}_{s , ( {j}_{1} , {k}_{1} )}^{B} {V}_{s , ( {j}_{2} , {k}_{2} )}^{B} {W}_{s , ( i , k )} ) {B}_{{j}_{1} , {k}_{1}} {B}_{{j}_{2} , {k}_{2}}\end{matrix}$$

but in general Aᵢ_{₁}_{,j}_{₁}Aᵢ_{₂}_{,j}_{₂}≠0≠Bⱼ_{₁}_{,k}_{₁}Bⱼ_{₂}_{,k}_{₂}, therefore—

$${\sum }_{s = 1}^{t} {U}_{s , ( {i}_{1} , {j}_{1} )}^{A} {V}_{s , ( {i}_{2} , {j}_{2} )}^{A} {W}_{s , ( i , k )} = {\sum }_{s = 1}^{t} {U}_{s , ( {j}_{1} , {k}_{1} )}^{B} {V}_{s , ( {j}_{2} , {k}_{2} )}^{B} {W}_{s , ( i , k )} = 0$$

to get—

$${\sum }_{j = 1}^{y} {A}_{i , j} {B}_{j , k} = \overline{{C}_{i , k}} = {\sum }_{{i}_{1} = 1}^{x} {\sum }_{{j}_{1} = 1}^{y} {\sum }_{{j}_{2} = 1}^{y} {\sum }_{{k}_{1} = 1}^{z} {A}_{{i}_{1} , {j}_{1}} {B}_{{j}_{2} , {k}_{1}} \cdot ( {\sum }_{s = 1}^{t} {V}_{s , ( {i}_{1} , {j}_{1} )}^{A} {U}_{s , ( {j}_{2} , {k}_{1} )}^{B} {W}_{s , ( i , k )} + {U}_{s , ( {i}_{1} , {j}_{1} )}^{A} {V}_{s , ( {j}_{2} , {k}_{1} )}^{B} {W}_{s , ( i , k )} )$$

Using the same technique obtains—

$${\sum }_{s = 1}^{t} ( {V}_{s , ( {i}_{1} , {j}_{1} )}^{A} {U}_{s , ( {j}_{2} , {k}_{1} )}^{B} + {U}_{s , ( {i}_{1} , {j}_{1} )}^{A} {V}_{s , ( {j}_{2} , {k}_{1} )}^{B} ) {W}_{s , ( i , k )} = {δ}_{{i}_{1} , i} \cdot {δ}_{{j}_{1} , {j}_{2}} \cdot {δ}_{{k}_{1} , k}$$

Proof of Theorem 3.2: Denote ALG_{O}= [symbol] U^{O}, V^{O}, W^{O} [symbol] ^{⊗k}. Use the composition from claim 3.8 to compose ALGₒ with (U^{I}, V^{I}, W^{I}). Since ALG_{O}=(U, V, W) is a ((ab)^{k}, (bc)^{k}, (ac)^{k}; t^{k})—algorithm that has dᵤ^{k} distinct rows in U and dᵥ^{k} distinct rows in V, the composed algorithm is an (X, Y, Z; t^{k}·t_{AB}, dᵤ^{k}·t_{A}, dᵥ^{k}·t_{B})^{C}—algorithm.

Let Q be the number of linear operations ALGₒ uses in each part (e.g., its decoding matrix uses Qw operations). By claim 2.19, it may be concluded that

$${Q}_{u} = \frac{{q}_{u}}{t - ab} ( {t}^{k} - {( ab )}^{k} ) , \\ {Q}_{v} = \frac{{q}_{v}}{t - bc} ( {t}^{k} - {( bc )}^{k} ) and {Q}_{w} = \frac{{q}_{w}}{t - ac} ( {t}^{k} - {( ac )}^{k} ) .$$

Note that W_{A}=(W_{A}^{O})^{⊗k}, so applying it is equivalent to applying W_{A}^{O} recursively takes k times. The [symbol] -th′ recursive step (where the blocks are of size

$$\frac{{a}^{k}}{{a}^{ℓ + 1}} \times \frac{{c}^{k}}{{c}^{ℓ + 1}} )$$

takes

$${d}_{u}^{ℓ} ( {q}_{w}^{A} \frac{{a}^{k} {c}^{k}}{{( ac )}^{ℓ + 1}} )$$

linear operations. Combining the costs of all the steps, it may be concluded that—

$$\begin{matrix}{Q}_{w}^{A} = {\sum }_{ℓ = 0}^{k - 1} {d}_{u}^{ℓ} ( {q}_{w}^{A} \frac{{a}^{k} {c}^{k}}{{( ac )}^{ℓ + 1}} ) \\ = {q}_{w}^{A} \frac{{a}^{k} {c}^{k}}{ac} {\sum }_{ℓ = 0}^{k - 1} {( \frac{{d}_{u}}{ac} )}^{ℓ} \\ = {q}_{w}^{A} \frac{{a}^{k} {c}^{k}}{ac} \cdot \frac{{( \frac{{d}_{u}}{ac} )}^{k} - 1}{\frac{{d}_{u}}{ac} - 1} \\ = \frac{{q}_{w}^{A}}{{d}_{u} - ac} ( {d}_{u}^{k} - {( ac )}^{k} )\end{matrix}$$

Similarly

$${Q}_{w}^{B} = \frac{{q}_{w}^{B}}{{d}_{v} - ac} ( {d}_{v}^{k} - {( ac )}^{k} ) , \\ {Q}_{{u}^{′}} = \frac{{q}_{{u}^{′}}}{{d}_{u} - ab} ( {d}_{u}^{k} - {( ab )}^{k} ) and {Q}_{{v}^{′}} = \frac{{q}_{{v}^{′}}}{{d}_{v} - bc} ( {d}_{v}^{k} - {( bc )}^{k} ) .$$

Now by claim 3.8, Algorithm 2 is an (X, Y, Z; t^{k}. T_{AB}, dᵤ^{k}·ta, dᵥ^{k}·t_{B})^{C}—algorithm that uses

$$( {Q}_{u} + 2 {Q}_{{u}^{′}} ) xy + ( {Q}_{v} + 2 {Q}_{{v}^{′}} ) yz + ( {Q}_{w} + {Q}_{w}^{A} + {Q}_{w}^{B} ) xz + {t}^{k} {s}_{AB} + {d}_{u}^{k} \cdot {s}_{A} + {d}_{v}^{k} \cdot {s}_{B} + {( ac )}^{k} {s}_{M} = ( \frac{{q}_{u}}{t - ab} ( {t}^{k} - {( ab )}^{k} ) + \frac{2 {q}_{{u}^{′}}}{{d}_{u} - ab} ( {d}_{u}^{k} - {( ab )}^{k} ) ) xy + {t}^{k} {s}_{AB} + {d}_{u}^{k} \cdot {s}_{A} + {d}_{v}^{k} \cdot {s}_{B} + {( ac )}^{k} {s}_{M} + ( \frac{{q}_{v}}{t - bc} ( {t}^{k} - {( bc )}^{k} ) + \frac{2 {q}_{{v}^{′}}}{{d}_{v} - bc} ( {d}_{v}^{k} - {( bc )}^{k} ) ) yz + ( \frac{{q}_{w}}{t - ac} ( {t}^{k} - {( ac )}^{k} ) + \frac{{q}_{w}^{A}}{{d}_{u} - ac} ( {d}_{u}^{k} - {( ac )}^{k} ) + \frac{{q}_{w}^{B}}{{d}_{v} - ac} ( {d}_{v}^{k} - {( ac )}^{k} ) ) xz = ( \frac{{q}_{u} xy}{t - ab} + \frac{{q}_{v} yz}{t - bc} + \frac{{q}_{w} xz}{t - ac} + {s}_{AB} ) {t}^{k} - ( \frac{{q}_{w}}{t - ac} + \frac{{q}_{w}^{A}}{{d}_{u} - ac} + \frac{{q}_{w}^{B}}{{d}_{v} - ac} ) XZ + ( \frac{2 {q}_{{u}^{′}}}{{d}_{u} - ab} + \frac{{q}_{w}^{A} xz}{{d}_{u} - ac} + {s}_{A} ) {d}_{u}^{k} + ( \frac{2 {q}_{{v}^{′}}}{{d}_{v} - bc} + \frac{{q}_{w}^{B} xz}{{d}_{v} - ac} + {s}_{B} ) {d}_{v}^{k} - ( \frac{{q}_{u}}{t - ab} + \frac{2 {q}_{{u}^{′}}}{{d}_{u} - ab} ) XY - ( \frac{{q}_{v}}{t - bc} + \frac{2 {q}_{{v}^{′}}}{{d}_{v} - bc} ) YZ + {( ac )}^{k} {s}_{M}$$

linear operations.
Proof of claim 3.5: First note that computing U^{o}·Â is the same operation as computing (U^{O}⊗I_{xy}). \vec{A} where I_{xy} is the identity matrix of size xy×xy. For every 1≤i≤t denote Aᵢ^{E}=(U^{O}·Â), and Bᵢ^{E}=(V^{O},·\hat{B})ᵢ.

Now multiply Aᵢ^{E} by Bᵢ^{E} for every i using [symbol] U^{I}, V^{I}, W^{I} [symbol] , to compute—

$$( \begin{matrix}{( {W}^{I} )}^{T} ( ( {U}^{I} \cdot ( \begin{matrix}{A}_{1}^{E} \\ {B}_{1}^{E}\end{matrix} ) ) ⊙ ( {V}^{I} \cdot ( \begin{matrix}{A}_{1}^{E} \\ {B}_{1}^{E}\end{matrix} ) ) ) \\ ⋮ \\ {( {W}^{I} )}^{T} ( ( {U}^{I} \cdot ( \begin{matrix}{A}_{t}^{E} \\ {B}_{t}^{E}\end{matrix} ) ) ⊙ ( {V}^{I} \cdot ( \begin{matrix}{A}_{t}^{E} \\ {B}_{t}^{E}\end{matrix} ) ) )\end{matrix} ) = {I}_{t} ⊗ {( {W}^{I} )}^{T} ( ( \begin{matrix}{U}^{I} \cdot ( \begin{matrix}{A}_{1}^{E} \\ {B}_{1}^{E}\end{matrix} ) \\ ⋮ \\ {U}^{I} \cdot ( \begin{matrix}{A}_{t}^{E} \\ {B}_{t}^{E}\end{matrix} )\end{matrix} ) ⊙ ( \begin{matrix}{V}^{I} \cdot ( \begin{matrix}{A}_{1}^{E} \\ {B}_{1}^{E}\end{matrix} ) \\ ⋮ \\ {V}^{I} \cdot ( \begin{matrix}{A}_{t}^{E} \\ {B}_{t}^{E}\end{matrix} )\end{matrix} ) )$$

Since

$$( {I}_{t} ⊗ {U}_{A}^{I} ) \cdot ( ( {U}^{O} ⊗ {I}_{xy} ) \cdot \vec{A} ) = ( {I}_{t} ⊗ {U}_{A}^{I} ) \cdot ( {U}^{O} ⊗ {I}_{xy} ) \cdot \vec{A} = ( {U}^{O} ⊗ {U}_{A}^{I} ) \cdot \vec{A}$$

The result is—

$$( \begin{matrix}{U}^{I} \cdot ( \begin{matrix}{A}_{1}^{E} \\ {B}_{1}^{E}\end{matrix} ) \\ ⋮ \\ {U}^{I} \cdot ( \begin{matrix}{A}_{t}^{E} \\ {B}_{t}^{E}\end{matrix} )\end{matrix} ) = ( \begin{matrix}{U}_{A}^{I} \cdot {A}_{1}^{E} + {U}_{B}^{I} {B}_{1}^{E} \\ ⋮ \\ {U}_{A}^{I} \cdot {A}_{t}^{E} + {U}_{B}^{I} {B}_{t}^{E}\end{matrix} ) = ( \begin{matrix}{U}_{A}^{I} \cdot {A}_{1}^{E} \\ ⋮ \\ {U}_{A}^{I} \cdot {A}_{t}^{E}\end{matrix} ) + ( \begin{matrix}{U}_{B}^{I} {B}_{1}^{E} \\ ⋮ \\ {U}_{B}^{I} {B}_{t}^{E}\end{matrix} ) = ( {I}_{t} ⊗ {U}_{A}^{I} ) ( \begin{matrix}{A}_{1}^{E} \\ ⋮ \\ {A}_{t}^{E}\end{matrix} ) + ( {I}_{t} ⊗ {U}_{B}^{I} ) ( \begin{matrix}{B}_{1}^{E} \\ ⋮ \\ {B}_{t}^{E}\end{matrix} ) = ( {I}_{t} ⊗ {U}_{A}^{I} ) ( {U}^{O} ⊗ {I}_{xy} ) \cdot \vec{A} + ( {I}_{t} ⊗ {U}_{B}^{I} ) ( {V}^{O} ⊗ {I}_{yz} ) \cdot \vec{B} = ( {U}^{O} ⊗ {U}_{A}^{I} ) \cdot \vec{A} + ( {V}^{O} ⊗ {U}_{B}^{I} ) \cdot \vec{B} = ( {U}^{O} ⊗ {U}_{A}^{I} , {V}^{O} ⊗ {U}_{B}^{I} ) \cdot ( \begin{matrix}\vec{A} \\ \vec{B}\end{matrix} )$$

meaning

$$( \begin{matrix}{( {W}^{I} )}^{T} ( ( {U}^{I} \cdot ( \begin{matrix}{A}_{1}^{E} \\ {B}_{1}^{E}\end{matrix} ) ) ⊙ ( {V}^{I} \cdot ( \begin{matrix}{A}_{1}^{E} \\ {B}_{1}^{E}\end{matrix} ) ) ) \\ ⋮ \\ {( {W}^{I} )}^{T} ( ( {U}^{I} \cdot ( \begin{matrix}{A}_{t}^{E} \\ {B}_{t}^{E}\end{matrix} ) ) ⊙ ( {V}^{I} \cdot ( \begin{matrix}{A}_{t}^{E} \\ {B}_{t}^{E}\end{matrix} ) ) )\end{matrix} ) = {( {I}_{t} ⊗ {W}^{I} )}^{T} ( ( ( {U}^{O} ⊗ {U}_{A}^{I} , {V}^{O} ⊗ {U}_{B}^{I} ) \cdot ( \begin{matrix}\vec{A} \\ \vec{B}\end{matrix} ) ) ⊙ ( ( {U}^{O} ⊗ {V}_{A}^{I} , {V}^{O} ⊗ {V}_{B}^{I} ) \cdot ( \begin{matrix}\vec{A} \\ \vec{B}\end{matrix} ) ) )$$

After multiplying all the blocks, use W^{O} to decode the result. This operation is equivalent to multiplying (W^{O}⊗I_{ac})^{T} by the result. (W^{O}⊗I_{ac})^{T}(Iₜ⊗W¹)^{T}=(W^{O}⊗W^{I})^{T}, finishing the proof:

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In the description and claims, each of the terms “substantially,” “essentially,” and forms thereof, when describing a numerical value, means up to a 20% deviation (namely, +20%) from that value. Similarly, when such a term describes a numerical range, it means up to a 20% broader range-10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

1. A system comprising:
at least one hardware processor; and
a non-transitory computer-readable storage medium having stored thereon program instruction, the program instructions executable by the at least one hardware processor to:
receive, as input, matrices A, B and a linear combination of blocks for a main multiplications operation with respect to said input matrices A, B,
apply a first matrix multiplication algorithm to calculate separately:
(i) the main multiplications of said input matrices A, B, using said linear combination of blocks,
(ii) correction terms for said input matrix A, and
(iii) correction terms for said input matrix B, and
combine the results of said calculating, to obtain a matrix multiplication operation result C of said input matrices A, B,
wherein said first matrix multiplication algorithm calculates said main multiplications using a computer system comprising one or more hardware processors, by replacing at least some multiplication operations with addition operations, thereby reducing a total number of arithmetic operations required to be performed by said computer system, and
wherein said replacing results in an increase in a communication cost within said computer system of no more than a low order term.

2. The system of claim 1, wherein said program instructions are further executable to apply a recursive non-commutative second matrix multiplication algorithm to determine said linear combination of blocks.

3. (canceled)

4. (canceled)

5. (canceled)

6. The system of claim 1, wherein said first matrix multiplication algorithm comprises a commutative matrix multiplication algorithm.

7. The system of claim 1, wherein said applying of said first matrix multiplication algorithm comprises:
(i) receiving encoding/decoding matrices (U^{I}, V^{I}, W^{II}) of said first matrix multiplication algorithm; and
(ii) dividing said received encoding/decoding matrices into three algorithms (ALG_{A}, ALG_{B}, ALG_{AB}),
wherein ALG_{A} is configured to calculate the correction terms for said input matrix A that depend only on input matrix A, ALG_{B} is configured to calculate the correction terms for said input matrix B that depend only on input matrix B, and ALG_{AB} is configured to calculate the main multiplication of input matrices A, B.

8. The system of claim 1, wherein said calculating of said correction terms for said input matrices A, B utilizes duplicate rows in the respective encoding matrices for the correction terms for said input matrices A, B, respectively, to reduce the cost of said calculating of said correction terms.

9. The system of claim 2, wherein said applying of said recursive non-commutative second matrix multiplication algorithm further comprises applying a transformation to at least one of said input matrix A, input matrix B, and matrix multiplication operation result C, wherein said transformation comprises (i) multiplying by an invertible basis transformation that is homomorphic over the same linear space, and/or (ii) multiplying by a non-homomorphic transformation into a linear space of any intermediate dimension.

10. (canceled)

11. (canceled)

12. (canceled)

13. (canceled)

14. A computer-implemented method comprising:
receiving, as input, matrices A, B and a linear combination of blocks for a main multiplications operation with respect to said input matrices A, B;
applying a first matrix multiplication algorithm to calculate separately:
(i) the main multiplications of said input matrices A, B, using said linear combination of blocks,
(ii) correction terms for said input matrix A, and
(iii) correction terms for said input matrix B; and
combining the results of said calculating, to obtain a matrix multiplication operation result C of said input matrices A, B,
wherein said first matrix multiplication algorithm calculates said main multiplications using a computer system comprising one or more hardware processors, by replacing at least some multiplication operations with addition operations, thereby reducing a total number of arithmetic operations required to be performed by said computer system, and
wherein said replacing results in an increase in a communication cost within said computer system of [no more than a low order term].

15. The computer-implemented method of claim 14, further comprising applying a recursive non-commutative second matrix multiplication algorithm to determine said linear combination of blocks.

16. (canceled)

17. (canceled)

18. (canceled)

19. The computer-implemented method of claim 14, wherein said first matrix multiplication algorithm comprises a commutative matrix multiplication algorithm.

20. The computer-implemented method of claim 14, wherein said applying of said first matrix multiplication algorithm comprises:
(i) receiving encoding/decoding matrices (U^{I}, V^{I}, W^{II}) of said first matrix multiplication algorithm; and
(ii) dividing said received encoding/decoding matrices into three algorithms (ALG_{A}, ALG_{B}, ALG_{AB}),
wherein ALG_{A} is configured to calculate the correction terms for said input matrix A that depend only on input matrix A, ALG_{B} is configured to calculate the correction terms for said input matrix B that depend only on input matrix B, and ALG_{AB} is configured to calculate the main multiplication of input matrices A, B.

21. The computer-implemented method of claim 14, wherein said calculating of said correction terms for said input matrices A, B utilizes duplicate rows in the respective encoding matrices for the correction terms for said input matrices A, B, respectively, to reduce the cost of said calculating of said correction terms.

22. The computer-implemented method of claim 15, wherein said applying of said recursive non-commutative second matrix multiplication algorithm further comprises applying a transformation to at least one of said input matrix A, input matrix B, and matrix multiplication operation result C, wherein said transformation comprises (i) multiplying by an invertible basis transformation that is homomorphic over the same linear space, and/or (ii) multiplying by a non-homomorphic transformation into a linear space of any intermediate dimension.

23. (canceled)

24. (canceled)

25. (canceled)

26. (canceled)

27. A computer program product comprising a non-transitory computer-readable storage medium having program instructions embodied therewith, the program instructions executable by at least one hardware processor to:
receive, as input, matrices A, B and a linear combination of blocks for a main multiplications operation with respect to said input matrices A, B;
apply a first matrix multiplication algorithm to calculate separately:
(i) the main multiplications of said input matrices A, B, using said linear combination of blocks,
(ii) correction terms for said input matrix A, and
(iii) correction terms for said input matrix B; and
combine the results of said calculating, to obtain a matrix multiplication operation result C of said input matrices A, B,
wherein said first matrix multiplication algorithm calculates said main multiplications using a computer system comprising one or more hardware processors, by replacing at least some multiplication operations with addition operations, thereby reducing a total number of arithmetic operations required to be performed by said computer system, and
wherein said replacing results in an increase in a communication cost within said computer system of no more than a low order term.

28. The computer program product of claim 27, wherein said program instructions are further executable to apply a recursive non-commutative second matrix multiplication algorithm to determine said linear combination of blocks.

29. (canceled)

30. (canceled)

31. (canceled)

32. The computer program product of claim 27, wherein said first matrix multiplication algorithm comprises a commutative matrix multiplication algorithm.

33. The computer program product of claim 27, wherein said applying of said first matrix multiplication algorithm comprises:
(i) receiving encoding/decoding matrices (U′, v′, W^{I}) of said first matrix multiplication algorithm; and
(ii) dividing said received encoding/decoding matrices into three algorithms (ALG_{A}, ALG_{B}, ALG_{AB}),
wherein ALG_{A} is configured to calculate the correction terms for said input matrix A that depend only on input matrix A, ALG_{B} is configured to calculate the correction terms for said input matrix B that depend only on input matrix B, and ALG_{AB} IS configured to calculate the main multiplication of input matrices A, B.

34-61. (canceled)

62. The system of claim 1, wherein at least one of said one or more hardware processors is a tensor processing unit (TPU).

63. The system of claim 1, wherein said increase in said communication cost represents an increase in the number of (i) inter-processor communications among said one or more hardware processors, and/or (ii) communications within a memory hierarchy of at least one of said one or more hardware processors.

64. The computer-implemented method of claim 14, wherein at least one of said one or more hardware processors is a tensor processing unit (TPU).

65. The computer-implemented method of claim 14, wherein said increase in said communication cost represents an increase in the number of (i) inter-processor communications among said one or more hardware processors, and/or (ii) communications within a memory hierarchy of at least one of said one or more hardware processors.
